(19) United States
(12) Patent Application Publication
(10) Pub. No.: US 2025/0328733 A1
(43) Pub. Date: Oct. 23, 2025

(54) INFORMATION PROCESSING APPARATUS, ANALYSIS METHOD, AND STORAGE MEDIUM

(71) Applicant: NEC Corporation, Tokyo (JP)

(72) Inventor: Naoki YOSHINAGA, Tokyo (JP)

(73) Assignee: NEC Corporation, Tokyo (JP)

(21) Appl. No.: 19/175,084

(22) Filed: Apr. 10, 2025

(30) Foreign Application Priority Data
Apr. 19, 2024 (JP) 2024-068300

(51) Int. Cl. G06F 40/289; G06F 40/40

(52) U.S. Cl. CPC G06F 40/289; G06F 40/40

(57) ABSTRACT

In order to support use of various types of content, an information processing apparatus includes: an extraction unit that uses a language model to extract a matter described as an antecedent and/or a matter described as a consequent in pieces of content which are targets; and an analysis unit that associates, on the basis of a result of extraction by the extraction unit, a first matter described as an antecedent in content in which an intermediate matter is described as a consequent and a second matter described as a consequent in content in which the intermediate matter is described as an antecedent, the intermediate matter being described as an antecedent in a piece of content and as a consequent in another piece of content. A result of association by the analysis unit can be used for decision making based on matters described in the content used as the targets.

This Nonprovisional application claims priority under 35 U.S.C. § 119 on Patent Application No. 2024-068300 filed in Japan on Apr. 19, 2024, the entire contents of which are hereby incorporated by reference.

### TECHNICAL FIELD

The present disclosure relates to an information processing apparatus, an analysis method, and a storage medium.

### BACKGROUND ART

Analysis techniques for promoting use of various documents are well known. One example of the analysis techniques is a document processing apparatus disclosed in Patent Literature 1. This document processing apparatus: extracts, on the basis of a rule corresponding to a type of an association source document, words or phrases from the association source document; generates, from the words or phrases extracted, a search condition for an association destination document; and stores a relation between the association source document and the association destination document which satisfies the search condition.

### CITATION LIST

### Patent Literature

### [Patent Literature 1]

Japanese Patent Application Publication Tokukai No. 2010-108268

### SUMMARY OF INVENTION

### Technical Problem

The document processing apparatus disclosed in Patent Literature 1 is to analyze relations of documents that are classified into predetermined types such as “daily reports”, “weekly reports”, “acts”, and “laws and regulations”. In such documents, words or phrases that can be used in search for an association destination document are described in specific positions. Such description is used in analyzing the relations. Accordingly, in the document processing apparatus disclosed in Patent Literature 1, analysis targets are limited. In this regard, there is room for improvement in the document processing apparatus.

For example, it is assumed that a certain document X describes “in a case where a condition A is satisfied, an event B occurs” and that another document Y describes that “in a case where the event B occurs, an event C also occurs”. Both of these documents mention the event B. In this regard, both the document X and the document Y are related to each other. However, unless the document X describes the event B in a specific position corresponding to a type of the document X, the document processing apparatus disclosed in Patent Literature 1 cannot associate these documents to each other. Further, the document processing apparatus disclosed in Patent Literature 1 cannot associate pieces of content (i.e., images) other than documents.

The present disclosure has been made in view of the above, and an example object of the present disclosure is to provide a technique that makes it possible to support use of various types of content.

### Solution to Problem

An information processing apparatus in accordance with an example aspect of the present disclosure includes at least one processor, the at least one processor carrying out: an extraction process of extracting, from a plurality of pieces of content which are targets, at least one matter selected from the group consisting of a matter that is described as an antecedent and a matter that is described as a consequent in the content, with use of a language model trained by machine learning; and an analysis process of, in a case where a matter that is described as an antecedent in a certain piece of content among the plurality of pieces of content which are targets and that is also described as a consequent in another piece of content among the plurality of pieces of content is defined as an intermediate matter, associating, on the basis of a result of extraction in the extraction process, a first matter described as an antecedent in content in which the intermediate matter is described as a consequent and a second matter described as a consequent in content in which the intermediate matter is described as an antecedent.

An analysis method in accordance with an example aspect of the present disclosure includes: at least one processor carrying out an extraction process of extracting, from a plurality of pieces of content which are targets, at least one matter selected from the group consisting of a matter that is described as an antecedent and a matter that is described as a consequent in the content, with use of a language model trained by machine learning; and the at least one processor carrying out an analysis process of, in a case where a matter that is described as an antecedent in a certain piece of content among the plurality of pieces of content which are targets and that is also described as a consequent in another piece of content among the plurality of pieces of content is defined as an intermediate matter, associating, on the basis of a result of extraction in the extraction process, a first matter described as an antecedent in content in which the intermediate matter is described as a consequent and a second matter described as a consequent in content in which the intermediate matter is described as an antecedent.

A storage medium in accordance with an example aspect of the present disclosure is a computer-readable non-transitory storage medium in which an analysis program is stored, the analysis program causing a computer to carry out: an extraction process of extracting, from a plurality of pieces of content which are targets, at least one matter selected from the group consisting of a matter that is described as an antecedent and a matter that is described as a consequent in the content, with use of a language model trained by machine learning; and an analysis process of, in a case where a matter that is described as an antecedent in a certain piece of content among the plurality of pieces of content which are targets and that is also described as a consequent in another piece of content among the plurality of pieces of content is defined as an intermediate matter, associating, on the basis of a result of extraction in the extraction process, a first matter described as an antecedent in content in which the intermediate matter is described as a consequent and a second matter described as a consequent in content in which the intermediate matter is described as an antecedent.

### Advantageous Effects of Invention

An example aspect of the present disclosure yields an example advantage of making it possible to support use of various types of content.

### BRIEF DESCRIPTION OF DRAWINGS

FIG. 1 is a block diagram illustrating a configuration of an information processing apparatus in accordance with the present disclosure.

FIG. 2 is a flowchart illustrating a flow of an analysis method in accordance with the present disclosure.

FIG. 3 is a block diagram illustrating a configuration of another information processing apparatus in accordance with the present disclosure.

FIG. 4 is a diagram illustrating an example of extraction and association of matters described in documents.

FIG. 5 is a diagram illustrating an example of a logic model.

FIG. 6 is a flowchart illustrating a flow of a series of processes carried out by the information processing apparatus illustrated in FIG. 3.

FIG. 7 is a flowchart illustrating a flow of a series of processes in receiving a question and presenting an answer.

FIG. 8 is a diagram illustrating another example of extraction and association of matters described in documents.

FIG. 9 is a diagram illustrating still another example of extraction and association of matters described in documents.

FIG. 10 is a flowchart illustrating another example of a flow of a series of processes carried out by the information processing apparatus illustrated in FIG. 3.

FIG. 11 is a diagram illustrating still another example of extraction and association of matters described in documents.

FIG. 12 is a flowchart illustrating still another example of a flow of a series of processes carried out by the information processing apparatus illustrated in FIG. 3.

FIG. 13 is a diagram illustrating still another example of extraction and association of matters described in documents.

FIG. 14 is a block diagram illustrating a configuration of a computer that functions as an information processing apparatus in accordance with the present disclosure.

### DESCRIPTION OF EXAMPLE EMBODIMENTS

The following description will discuss example embodiments of the present invention. Note, however, that the present invention is not limited to the example embodiments described below, but can be altered in various ways by a skilled person in the art within the scope of the claims. For example, the present invention can also encompass, in its scope, any example embodiment derived by appropriately combining techniques (some or all of products or processes) employed in the example embodiments described below. Further, the present invention can also encompass, in its scope, any example embodiment derived by appropriately omitting some of the techniques employed in the example embodiments described below. Furthermore, the example advantages mentioned in the example embodiments described below are example advantages expected in the example embodiments described below, and are not intended to define an extension of the present invention. That is, any embodiment which does not provide the example advantages mentioned in the example embodiments described below can also be within the scope of the present invention.

### First Example Embodiment

The following description will discuss a first example embodiment, which is an example embodiment of the present invention, in detail with reference to the drawings. The present example embodiment is a basic form of example embodiments described later. Note that the scope of application of techniques which are employed in the present example embodiment is not limited to the present example embodiment. That is, the techniques which are employed in the present example embodiment can be employed also in the other example embodiments included in the present disclosure, provided that no particular technical problem occurs. Moreover, techniques which are indicated in the drawings referred to for describing the present example embodiment can be employed also in the other example embodiments included in the present disclosure, provided that no particular technical problem occurs.

### (Configuration of Information Processing Apparatus 1)

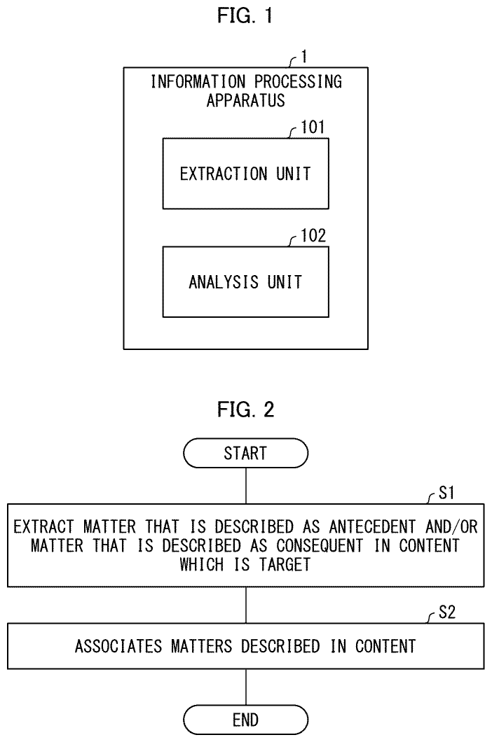

A configuration of an information processing apparatus 1 in accordance with the present example embodiment will be described with reference to FIG. 1. FIG. 1 is a block diagram illustrating the configuration of the information processing apparatus 1. The information processing apparatus 1 includes an extraction unit 101 and an analysis unit 102, as illustrated in FIG. 1.

With use of a language model trained by machine learning, the extraction unit 101 extracts, from a plurality of pieces of content which are targets, a matter described as an antecedent and/or a matter described as a consequent in the target pieces of content.

The above “matter described as an antecedent” is a matter that makes a pair with the “matter described as a consequent”. These matters are associated with each other such that if “the matter described as an antecedent” is true, the “matter described as a consequent” is also true. The above “antecedent” can be reworded as, for example, “condition”, “assumption” or “input”, and the above “consequent” can be reworded as, for example, “result”, “consequence”, “conclusion”, or “output”.

Further, the “content” only needs to include a matter corresponding to the above antecedent and a matter corresponding to the above consequent. For example, the “content” may be a document, that is, text format content, image format content, or content including both of text and an image.

Further, the above “language model” may be a model trained by machine learning to be capable of extracting, from the above content, a matter described as an antecedent and/or a matter described as a consequent in the content. For example, in a case where content which is a target is text data, a model that has learned, by machine learning, an arrangement of components (such as words) of a sentence and an arrangement of sentences in text may be applied as the language model. Furthermore, for example, in a case where content which is a target is image data, a model that has learned, by machine learning, a relationship between image data and a matter corresponding to an antecedent and/or a matter corresponding to a consequent in a target represented by the image data may be applied as the language model. Further, it is also possible to apply, as the language model, a combination of a model that extracts, from image data, a matter corresponding to an antecedent and/or a matter corresponding to a consequent and a model that extracts, from text data, a matter corresponding to an antecedent and/or a matter corresponding to a consequent.

Further, in a case where content which is a target is in a format other than text, the extraction unit 101 may perform the above-described extraction after converting that content into a text format. For example, in a case where content which is a target is image data, the extraction unit 101 may generate text data with use of a generative model that generates text indicating a target represented by the image data. Then, the extraction unit 101 may extract, with use of a language model, a matter corresponding to an antecedent and/or a matter corresponding to a consequent from the text data. Moreover, for example, in a case where content which is a target is voice data, the extraction unit 101 may first convert the voice data into text data and then extract, with use of a language model, a matter corresponding to an antecedent and/or a matter corresponding to a consequent from the text data. Note that it is possible to provide, in the information processing apparatus 1, a block which is different from the extraction unit 101 and cause the block to carry out a process for converting content into a text format, or it is possible to cause an apparatus other than the information processing apparatus 1 to carry out the process.

The analysis unit 102 associates, on the basis of a result of extraction by the extraction unit 101, a first matter that is described as an antecedent in content in which an intermediate matter is described as a consequent and a second matter described as a consequent in content in which the intermediate matter is described as an antecedent. The “intermediate matter” means a matter that is described as an antecedent in a certain piece of content among a plurality of pieces of content which are targets and that is also described as a consequent in another piece of content among the plurality of pieces of content which are targets.

As described above, the information processing apparatus 1 in accordance with the present example embodiment is configured to include: an extraction unit 101 that extracts, from a plurality of pieces of content which are targets, at least one matter selected from the group consisting of a matter that is described as an antecedent and a matter that is described as a consequent in the content, with use of a language model trained by machine learning; and an analysis unit 102 that, in a case where a matter that is described as an antecedent in a certain piece of content among the plurality of pieces of content which are targets and that is also described as a consequent in another piece of content among the plurality of pieces of content is defined as an intermediate matter, associating, on the basis of a result of extraction by the extraction unit 101, a first matter described as an antecedent in content in which the intermediate matter is described as a consequent and a second matter described as a consequent in content in which the intermediate matter is described as an antecedent.

It should be noted here that in content in which the first matter is described as an antecedent, the intermediate matter is described as a consequent. In other words, according to the content, the following relation exists: if the first matter is true, the intermediate matter is true.

On the other hand, in content in which the second matter is described as a consequent, the intermediate matter is described as an antecedent. In other words, according to the content, the following relation exists: if the intermediate matter is true, the second matter is true.

Therefore, it can be said that according to the above two pieces of content, the following relation exists: if the first matter is true, the intermediate matter is true, and if the intermediate matter is true, the second matter is true. Then, on the basis of this relation, it also can be said that the following relation exists: if the first matter is true, the second matter is true. The analysis unit 102 can extract the first matter and the second matter in such a relation. In this way, associating matters described in different pieces of content leads to new findings and promotion of use of the content.

Further, since a language model is used for extraction by the extraction unit 101, the content which is a target is not limited to a specific type of document, and can be any of various types of content. As described above, the information processing apparatus 1 yields an example advantage of making it possible to support use of various types of content.

Note that it is possible to use, in various applications, a result of analysis by the analysis unit 102, that is, a result of associating the first matter and the second matter. For example, the information processing apparatus 1 may present, to a user of the information processing apparatus 1, the result of associating the first matter and the second matter. This allow the user to obtain new findings. Further, the result of associating a first matter and a second matter can be used for decision making based on a matter described in content that is used as a target. For example, assume a case where the first matter is “50 g or more of food A is taken daily” and the second matter is “lifetime earnings are increased”. In this case, association of the above matters makes it possible to make a decision to take in 50 g or more of food A daily, on the basis of matters described in respective pieces of content.

Further, the information processing apparatus 1 may present, to a user on the basis of a result of associating the first matter and the second matter, content described in the first matter and/or content described in the second content. This allows the user to more accurately make a decision on the basis of text described in the first matter/the second matter in the content. Further, the result of associating the first matter and the second matter can be used for generating an answer in accordance with details of the content in response to a question from a user. This will be described in detail in a second example embodiment.

### (Analysis Program)

Functions of the information processing apparatus 1 above can be realized by a program. An analysis program in accordance with the present example embodiment causes a computer to function as: an extraction means that extracts, from a plurality of pieces of content which are targets, at least one matter selected from the group consisting of a matter that is described as an antecedent and a matter that is described as a consequent in the content, with use of a language model trained by machine learning; and an analysis means that, in a case where a matter that is described as an antecedent in a certain piece of content among the plurality of pieces of content which are targets and that is also described as a consequent in another piece of content among the plurality of pieces of content is defined as an intermediate matter, associates, on the basis of a result of extraction by the extraction means, a first matter described as an antecedent in content in which the intermediate matter is described as a consequent and a second matter described as a consequent in content in which the intermediate matter is described as an antecedent. This analysis program yields an example advantage of making it possible to support use of various types of content.

### (Flow of Analysis Method)

A flow of an analysis method in accordance with the present example embodiment will be described below with reference to FIG. 2. FIG. 2 is a flowchart illustrating the flow of the analysis method. Note that steps of the analysis method may be carried out by a processor of the information processing apparatus 1 or by a processor of another apparatus. Alternatively, the steps may be carried out by processors provided in respective different apparatuses.

In S1 (extraction process), at least one processor extracts, from a plurality of pieces of content which are targets, a matter that is described as an antecedent and/or a matter that is described as a consequent in the content, with use of a language model trained by machine learning.

In S2 (analysis process), the at least one processor associates, on the basis of a result of extraction in S1, a first matter described as an antecedent in content in which an intermediate matter is described as a consequent and a second matter described as a consequent in content in which the intermediate matter is described as an antecedent. As described above, the intermediate matter refers to a matter that is described as an antecedent in a certain piece of content among the plurality of pieces of content and that is also described as a consequent in another piece of content among the plurality of pieces of content.

As described above, the analysis method in accordance with the present example embodiment is configured to include: at least one processor carrying out an extraction process of extracting, from a plurality of pieces of content which are targets, at least one matter selected from the group consisting of a matter that is described as an antecedent and a matter that is described as a consequent in the content, with use of a language model trained by machine learning; and the at least one processor carrying out an analysis process of, in a case where a matter that is described as an antecedent in a certain piece of content among the plurality of pieces of content which are targets and that is also described as a consequent in another piece of content among the plurality of pieces of content is defined as an intermediate matter, associating, on the basis of a result of extraction in the extraction process, a first matter described as an antecedent in content in which the intermediate matter is described as a consequent and a second matter described as a consequent in content in which the intermediate matter is described as an antecedent. Therefore, the analysis method in accordance with the present example embodiment yields an example advantage of making it possible to support use of various types of content.

### Second Example Embodiment

A second example embodiment, which is an example embodiment of the present invention, will be described in detail with reference to the drawings. Members having functions identical to those of the respective members described in the foregoing example embodiment are given respective identical reference numerals, and a description of those members is omitted as appropriate. Note that the scope of application of techniques which are employed in the present example embodiment is not limited to the present example embodiment. That is, the techniques which are employed in the present example embodiment can be employed also in the other example embodiments included in the present disclosure, provided that no particular technical problem occurs. Moreover, techniques which are indicated in the drawings referred to for describing the present example embodiment can be employed also in the other example embodiments included in the present disclosure, provided that no particular technical problem occurs.

### (Configuration of Information Processing Apparatus 1A)

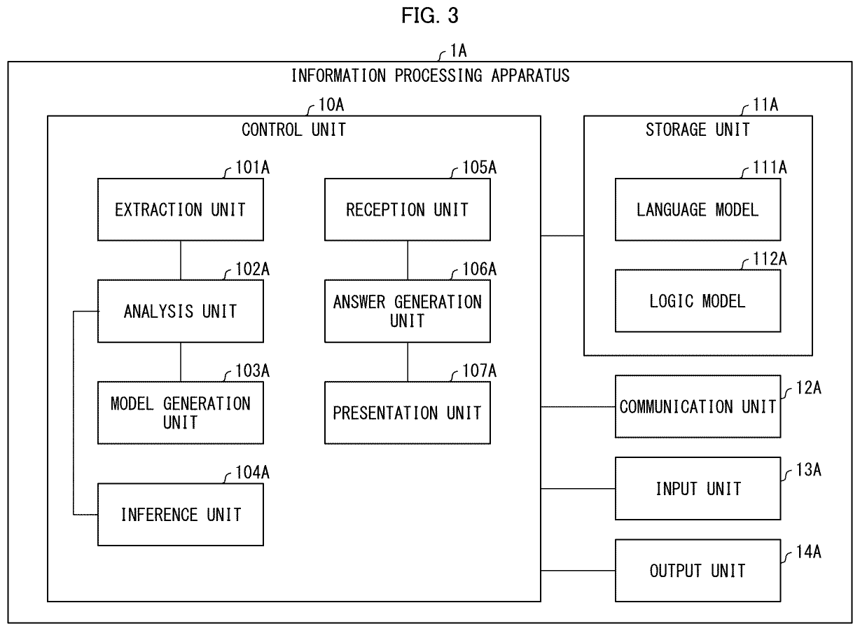

A configuration of an information processing apparatus 1A in accordance with the present example embodiment will be described below with reference to FIG. 3. FIG. 3 is a block diagram illustrating the configuration of the information processing apparatus 1A. The information processing apparatus 1A is an apparatus having a function of supporting use of content. The information processing apparatus 1A may be an apparatus whose main function is to support use of content, or may be a general-purpose apparatus which additionally has other functions. The information processing apparatus 1A may be a stationary apparatus or a portable apparatus.

As illustrated in FIG. 3, the information processing apparatus 1A includes: a control unit 10A that performs overall control of units of the information processing apparatus 1A; and a storage unit 11A that stores various kinds of data used by the information processing apparatus 1A. The information processing apparatus 1A further includes: a communication unit 12A that allows the information processing apparatus 1A to communicate with another apparatus; an input unit 13A that receives input to the information processing apparatus 1A; and an output unit 14A that allows the information processing apparatus 1A to output data. Then, the control unit 10A includes an extraction unit 101A, an analysis unit 102A, a model generation unit 103A, an inference unit 104A, a reception unit 105A, an answer generation unit 106A, and a presentation unit 107A. Further, a language model 111A and a logic model 112A are stored in the storage unit 11A. Note that the model generation unit 103A, the inference unit 104A, the reception unit 105A, the answer generation unit 106A, and the logic model 112A will be described in detail later.

With use of a language model 111A trained by machine learning, the extraction unit 101A similarly to the extraction unit 101 of the first example embodiment, extracts, from a plurality of pieces of content which are targets, a matter described as an antecedent and/or a matter described as a consequent in the content.

The following description will discuss an example in which content which is a target is a text format document. Examples of the document include: academic papers and the like; texts that are extracted from, for example, websites or user reviews which introduce products, services, and/or the like; and messages that are posted in social networking services (SNSs) and the like. Further, the content which is a target may be limited to content in a specific field. For example, by limiting the content which is a target to papers in a medical field, it is possible to analyze technical findings in the medical field. Further, for example, by limiting the content which is a target to healthcare-related documents, the information processing apparatus 1A can be used for healthcare. Note that, as described in the first example embodiment, the content which is a target is not limited to text format documents, but any content in an arbitrary format can be used as an analysis target. Therefore, the “document” in the following description can be read as any “content” in any format.

The language model 111A, like the language model described in the first example embodiment, may be a language model that has been trained by machine learning to extract, from content which is an analysis target, a matter described as an antecedent and/or a matter described as a consequent in the content. As described above, the content to be analyzed in the present example embodiment is a text format document. Accordingly, the language model 111A applied may be a model that has learned, by machine learning, an arrangement of components (such as words) of a sentence and an arrangement of sentences in text.

Note that the information processing apparatus 1A does not necessarily need to include the language model 111A, but may use the language model 111A stored in an apparatus external to the information processing apparatus 1A. In this case, the extraction unit 101A instructs an external apparatus including the language model 111A to extract a matter described as an antecedent and/or a matter described as a consequent in a document. Then, the extraction unit 101A acquires, from the external apparatus, a matter which the external apparatus has extracted with use of the language model 111A.

In a case an intermediate matter refers to a matter that is described as an antecedent in a certain piece of content among a plurality of pieces of content (documents in the present example embodiment) which are analysis targets and that is also described as a consequent in another piece of content among the plurality of pieces of content, the analysis unit 102A, like the analysis unit 102 of the first example embodiment, associates, on the basis of a result of extraction by the extraction unit 101, a first matter described as an antecedent in content in which the intermediate matter is described as a consequent and a second matter described as a consequent in content in which the intermediate matter is described as an antecedent.

The presentation unit 107A presents various types of information to a user of the information processing apparatus 1A, in order to support use of content. For example, the presentation unit 107A presents the logic model 112A to a user. For example, the presentation unit 107A may present the information by outputting the information to the output unit 14A or may present the information by outputting the information to a terminal apparatus or the like that is carried by a user. Further, an aspect of presentation is not particularly limited. For example, in a case where the presentation unit 107A is to present information which, like the logic model 112A, is preferably presented by use of an image, the presentation unit 107A only needs to output the information by display. Further, in a case where other information is to be presented, the presentation unit 107A may present the other information by display output, audio output, or print output.

As described above, the information processing apparatus 1A in accordance with the present example embodiment is configured to include: an extraction unit 101A that extracts, from a plurality of pieces of content (documents in the present example embodiment) which are targets, at least one matter selected from the group consisting of a matter that is described as an antecedent and a matter that is described as a consequent in the content, with use of a language model trained by machine learning; and an analysis unit 102A that, in a case where a matter that is described as an antecedent in a certain piece of content among the plurality of pieces of content which are targets and that is also described as a consequent in another piece of content among the plurality of pieces of content is defined as an intermediate matter, associates, on the basis of a result of extraction by the extraction unit 101, a first matter described as an antecedent in content in which the intermediate matter is described as a consequent and a second matter described as a consequent in content in which the intermediate matter is described as an antecedent. This yields an example advantage of making it possible to support use of various types of content.

### Example 1 of Extraction and Association: Start from Extraction of Antecedent

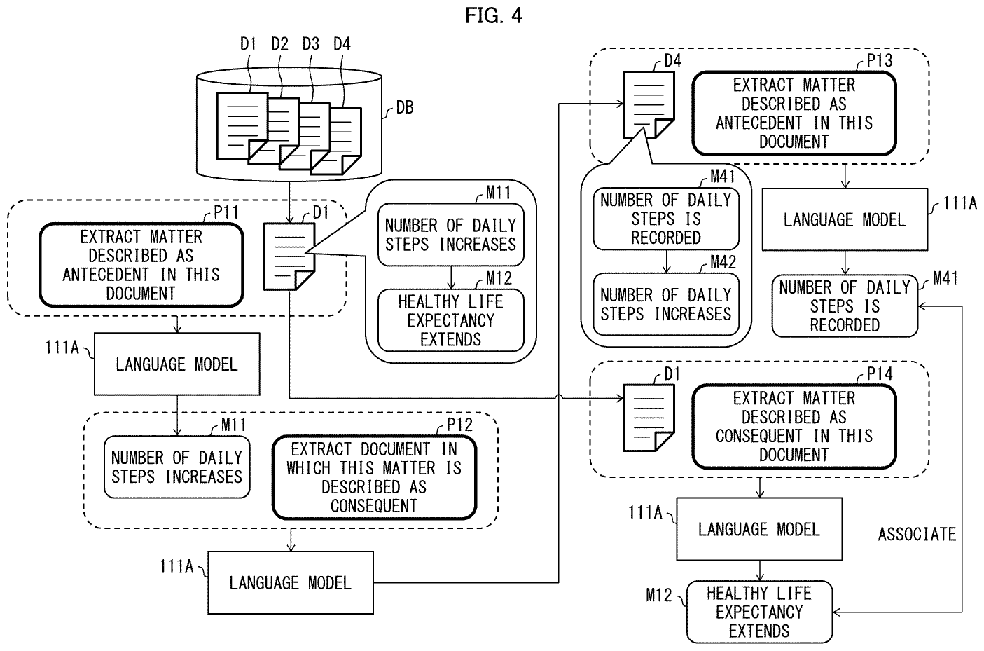

Extraction by the extraction unit 101A and association by the analysis unit 102A will be described with reference to a specific example illustrated in FIG. 4. FIG. 4 is a diagram illustrating an example of extraction and association of matters described in documents by the extraction unit 101A and the analysis unit 102A. Note that matters described in the documents illustrated in FIG. 4 is for describing extraction and association by the extraction unit 101A and the analysis unit 102A, and whether or not content of the matters described is correct is insignificant here. This also applies to other examples which will be described later.

In the example of FIG. 4, documents D1 to D4 which are recorded in a database (DB) are pieces of content which are analysis targets. Note that only four documents which are targets are illustrated in FIG. 4 for simplicity, but the number of documents which are targets only need to be two or more and is not particularly limited. Further, the documents which are targets do not necessarily need to be recorded in a single DB. It is possible to use, as the analysis targets, documents that are recorded in a plurality of DBs or a plurality of storage apparatuses in a distributed manner.

In the example of FIG. 4, the extraction unit 101A reads out the documents D1 to D4 one by one which are recorded in the DB, and extracts, from each of the documents thus read out, a matter described as an antecedent in the document. FIG. 4 shows extraction from the document D1. As illustrated in FIG. 4, in the document D1, a matter M11 “the number of daily steps increases” is described as an antecedent and in addition, a matter M12 “healthy life expectancy extends” is described as a consequent that corresponds to the antecedent.

The extraction unit 101A inputs, to the language model 111A, a prompt together with the document read from the DB. This prompt instructs extraction of a matter described as an antecedent in the document. Thus, the extraction unit 101A causes the language model 111A to extract, from the document, the matter described as an antecedent in the document. For example, as illustrated in FIG. 4, the extraction unit 101A may input, to the language model 111A, the document D1 and a fixed prompt P11 “extract a matter described as an antecedent in this document”. This makes it possible to extract the matter M11 from the document D1 as illustrated in FIG. 4. Note that the matter M11 extracted is text data. Further, the extraction unit 101A may extract, from a single document, a plurality of matters each described as an antecedent in the document.

Next, the extraction unit 101A extracts a document in which the matter extracted as described above is described as a consequent. For example, as illustrated in FIG. 4, the extraction unit 101A may input, to the language model 111A, the matter M11 and a fixed prompt P12 “extract a document in which this matter is described as a consequent”. Further, the extraction unit 101A only needs to specify, as extraction candidates, the documents D1 to D4 which are recorded in the DB. Thus, in the example of FIG. 4, the document D4 is extracted. In the document D4, a matter M41 “the number of daily steps is recorded” is described as an antecedent and in addition, a matter M42 “the number of daily steps increases” is described as a consequent that corresponds to the antecedent.

Here, the matter M42 and the matter M11 in the example of FIG. 4 are identical to each other. However, if there is any description that is identical to the matter M11 in terms of content, it is possible to extract a document that includes the description even in a case where there is a difference in expression. This is because the extraction unit 101A to carry out extraction with use of the language model 111A. Note that in a case where a plurality of matters described as antecedents are extracted from the document D1, the extraction unit 101A tries to extract, for each of the matters extracted, a document in which the matter is described as a consequent. Further, in a case where no corresponding document is extracted, the extraction unit 101A reads out another document from the DB and extracts, from the another document, a matter described as an antecedent in the document.

Next, the extraction unit 101A inputs, to the language model 111A, the document D4 that has been extracted as described above and a prompt P13 that instructs extraction of a matter described as an antecedent in the document D4. Thus, the extraction unit 101A causes the language model 111A to extract a matter described as an antecedent in the document D4. This makes it possible to extract the matter M41 from the document D4 as illustrated in FIG. 4.

Further, the extraction unit 101A inputs, to the language model 111A, the document D1 and a prompt P14 that instructs extraction of a matter described as a consequent in the document D1. Thus, the extraction unit 101A causes the language model 111A to extract a matter described as a consequent in the document D1. This makes it possible to extract the matter M12 from the document D1 as illustrated in FIG. 4.

The analysis unit 102A associates the matter M41 that has been extracted from the document D4 as described above and the matter M12 that has been extracted from the document D1 as described above with each other. This leads to findings that if “the number of daily steps is recorded”, “healthy life expectancy extends”. Note that the “intermediate matter” in the example of FIG. 4 includes the matters M11 and M42.

As described above, with use of the language model 111A, the extraction unit 101A may: (1) extract a matter (the matter M11 in the example of FIG. 4) described as an antecedent in first content (the document D1 in the example of FIG. 4) that is one of a plurality of pieces of content which are analysis targets; (2) extract, from among the plurality of pieces of content, second content (the document D4 in the example of FIG. 4) in which the matter extracted is described as a consequent; (3) extract, as the first matter, a matter (the matter M41 in the example of FIG. 4) described as an antecedent in the second content; and (4) extract, as the second matter, a matter (M12 in the example of FIG. 4) described as a consequent in the first content. This makes it possible to obtain an example advantage of making it possible to derive new findings by logically associating matters described in a plurality of pieces of content.

### (Logic Model)

The model generation unit 103A generates a logic model on the basis of a result of association carried out by the analysis unit 102A as described above. The logic model is a model that indicates a logical relation between matters described in a plurality of pieces of content (documents in the present example embodiment) which are analysis targets. The information processing apparatus 1A includes the model generation unit 103A. This makes it possible to obtain, in addition to the example advantage yielded by the information processing apparatus 1, an example advantage of making it possible to achieve modelling of matters described in a plurality of pieces of content which are analysis targets on the basis of a logical relation between the matters.

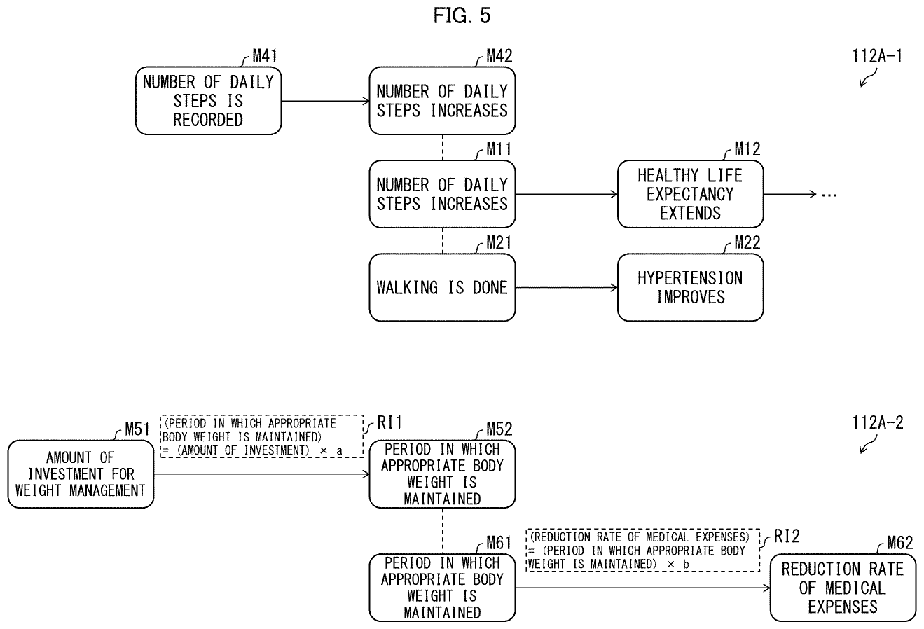

The logic model generated is stored, as the logic model 112A, in the storage unit 11A. The following description will discuss the logic model 112A with reference to FIG. 5. FIG. 5 is a diagram illustrating an example of the logic model 112A. Note that although the logic model 112A is represented in a graph format in FIG. 5, the logic model 112A only needs to indicate a logical relation between matters and need not be in a graph format.

The logic model 112A-1 illustrated in FIG. 5 is an example of the logic model 112A that is generated by the model generation unit 103A. The logic model 112A-1 shows, as nodes, a first matter and a second matter that are extracted from a plurality of pieces of content which are analysis targets (documents in the present example embodiment). The logic model 112A-1 indicates logical relations between nodes and can be expressed as a logic graph. Note that, as described above, the first matter refers to a matter described as an antecedent in content in which an intermediate matter is described as a consequent and the second matter is a matter described as a consequent in content in which the intermediate matter is described as an antecedent.

Further, in the logic model 112A-1, the relations between the nodes, that is, relations between matters described in the content are represented by arrow edges and dashed line edges. Nodes connected by an arrow edge are related to each other as an antecedent and a consequent, and a node on a root side of that arrow corresponds to an antecedent and a tip side of the arrow corresponds to a consequent. For example, in the logic model 112A-1, a node corresponding to the matter M41 and a node corresponding to the matter M42 that are illustrated in FIG. 4 are connected to each other by an arrow edge. Of these nodes, the node corresponding to the matter M41 is on a root side of the arrow, and the node corresponding to the matter M42 is on a tip side of the arrow. This indicates that the matter M41 is an antecedent and the matter M42 is a consequent. The relation between these nodes is specified from the document 4D (see FIG. 4) that describes the matter M41 and the matter M42. Note that although in FIG. 4, it is not shown that the matter M42 is extracted from the document D4, the extraction unit 101A can extract the matter M42 by inputting, to the language model 111A, the document D4 and the prompt P14 illustrated in FIG. 4. In other words, the extraction unit 101A may extract an intermediate matter for generation of the logic model 112A-1.

On the other hand, the dashed line edges are based on association by the analysis unit 102A, and nodes that are connected by a dashed line edge indicates the intermediate matter. Specifically, nodes corresponding to the matters M42, M11, and M21 each indicate the intermediate matter. Note that matters M21 and M22 are matters (the former is an antecedent and the latter is a consequent) extracted from the document D2 illustrated in FIG. 4.

In this way, the logic model 112A-1 shows, through the nodes of the intermediate matter, a logical relation of matters described in different documents. Therefore, by presenting the logic model 112A to a user of the information processing apparatus 1A, the user can recognize the relation. The presentation unit 107A may be caused to present the logic model 112A-1. Further, in presenting the logic model 112A-1, the presentation unit 107A may present, in association with a matter described in each of the documents, a document from which the matter is extracted. For example, in the example of FIG. 5, the presentation unit 107A may present information which indicates that the matters M41 and M42 are extracted from the document D4, in such a manner that the information is associated with the nodes of the matters M41 and M42 or an edge connecting these nodes.

The model generation unit 103A sets, as nodes, respective matters which are targets of association by the analysis unit 102A, that is, the first matter and the second matter described above. Then, the model generation unit 103A can generate the logic model 112A-1 by representing, by an edge, a relation between the nodes. Further, as illustrated in FIG. 5, the model generation unit 103A may also include the intermediate matter as a node of the logic model 112A-1.

Further, the model generation unit 103A can associate matters described in three or more documents with one another in the logic model 112A. For example, it is assumed that in the document D3 in the example of FIGS. 4 and 5, “healthy life expectancy extends” is described as an antecedent (hereinafter, referred to as matter M31) and “a base of a local community is strengthened” (hereinafter referred to as matter M32) is described as a consequent that corresponds to the antecedent.

In this case, the extraction unit 101A extracts, from the document D3, the matter M31 and tries to extract, from the documents D1 to D4, a document in which the matter M31 is described as a consequent. As a result of this trial, the document D1 is extracted. Then, the extraction unit 101A extracts the matter M11 described as an antecedent in the document D1 and extracts the matter M32 described as a consequent in the document D3. Thus, the analysis unit 102A can associate the matter M11 and M32 with each other. Further, the matter M11 is associated with the matter M41. Accordingly, the model generation unit 103A generates, on the basis of the above association by the analysis unit 102A, a logic model 112A that indicates the following logical relations: if the matter M41 is true, the matters M42 and M11 (and M21) are true; if the matter M11 is true, the matter M12 and M31 are true; and if the matter M31 is true, the matter M 32 is true.

Further, the model generation unit 103A can update the logic model 112A. For example, it is assumed that: after the logic model 112A-1 illustrated in FIG. 5 is generated, analysis is carried out on a new document D7; and, then, by specifying the matter M22 as an intermediate matter, the matter M21 and a matter M72 described in the document D7 are associated with each other. In this case, the model generation unit 103A adds, to the logic model 112A-1, a node corresponding to the matter M72 and a node corresponding to a matter M71 which is described in the document D7 as an antecedent corresponding to the matter M72. Then, the model generation unit 103A connects, by a dashed line edge, the node corresponding to the matter M71 and the node corresponding to the matter M22, and also connects, by an arrow edge, the node corresponding to the matter M71 and the node corresponding to the matter M72. Thus, the logic model 112A-1 is updated.

### (Relation Information)

Further, the presentation unit 107A may associate matters described in documents and present relation information indicating a relation between the matters. The relation information may be extracted by the extraction unit 101A. For example, in extracting a matter described as an antecedent from a document, the extraction unit 101A may input, to the language model 111A, a prompt for requesting extraction of a description that indicates a relation between the matter to be extracted and a matter described as a consequent that corresponds to the matter to be extracted. The description thus extracted can be used as the relation information.

For example, in a case where the document D1 in the example of FIG. 4 describes a mathematical expression indicating a relation between an amount of increase in the number of daily steps and a degree of extension of healthy life expectancy, the extraction unit 101A can extract this mathematical expression as the relation information. Then, the presentation unit 107A can present, as the relation information, the mathematical expression extracted. For example, the presentation unit 107A may display the above extracted mathematical expression in association with an edge that connects the node corresponding to the matter M11 and a node corresponding to the matter M12.

The inference unit 104A infers the relation between the first matter and the second matter by using the relation information described above. This will be described with reference to a logic model 112A-2 illustrated in FIG. 5. The logic model 112A-2 includes nodes corresponding to the following matters, respectively: a matter M51 described as an antecedent in a document D5; a matter M52 described as a consequent in the document D5; a matter M61 described as an antecedent in a document D6; and a matter M62 described as a consequent in the document D6. Of these, the matters M52 and M61 are each an intermediate matter, and the matters M51 and M62 are associated via these matters.

Further, in the logic model 112A-2, relation information RI1 indicating a relation between the matters M51 and M52 is associated with an edge that connects the node corresponding to the matter M51 and the node corresponding to the matter M52. Similarly, relation information RI2 indicating a relation between the matters M61 and M62 is associated with an edge that connects the node corresponding to the matter M61 and the node corresponding to the matter M62.

The relation information RI1 is information that is extracted from the document D5, and is a mathematical expression that indicates a relationship between a period in which an appropriate body weight is maintained and an amount of investment for weight management. According to this mathematical expression, the period in which an appropriate body weight is maintained is proportional to the amount of investment for weight management, and a proportional constant of the period and the amount is a. Further, the relation information RI2 is information that is extracted from the document D6, and is a mathematical expression that indicates a relation between a reduction rate of medical expenses and a period in which an appropriate body weight is maintained. According to this mathematical expression, the reduction rate of medical expenses is proportional to the period in which an appropriate body weight is maintained, and a proportional constant of the reduction rate and the period is b.

The inference unit 104A uses the relation information of the reduction rate and the period to infer the relation between the matter M51 (corresponding to the first matter described above) and the matter M62 (corresponding to the second matter described above). Specifically, the inference unit 104A infers, from the relation information RI1 and the relation information RI2, that the relation between the amount of investment for weight management and the reduction rate of medical expenses is expressed by the following mathematical expression: “(amount of investment for weight management)=(reduction rate of medical expenses)/a·b”.

Further, the inference unit 104A can infer, on the basis of a result of the above inference, (i) the reduction rate of medical expenses in a case where the amount of investment for weight management is a certain value and (ii) an amount of change in the reduction rate of medical expenses in a case where an amount of change in the amount of investment for weight management is a certain value. In this way, the inference unit 104A can also carry out various simulations on the basis of the result of the above-described inference. Note that the result of inference by the inference unit 104A only needs to be recorded in association with the logic model 112A.

As described above, the information processing apparatus 1A includes the inference unit 104A that infers a relation between the first matter and the second matter by using (i) first relation information (RI1 in the example of the logic model 112A-2) indicating a relation between the first matter (M51 in the example of the logic model 112A-2) and the intermediate matter which are extracted from the content in which the first matter is described as an antecedent and the intermediate matter is described as a consequent and (ii) second relation information (RI2 in the example of the logic model 112A-2) indicating a relation between the intermediate matter and the second matter (M62 in the example of the logic model 112A-2) which are extracted from the content in which the intermediate matter is described as an antecedent and the second matter is described as a consequent. This makes it possible to obtain, in addition to the example advantage yielded by the information processing apparatus 1, an example advantage of making it possible to obtain a result of analysis regarding the relation between the first matter and the second matter. Further, use of the result of analysis makes it possible to carry out various simulations on the basis of the result of inference.

Note that the inference unit 104A can similarly infer relations between matters that are described in three or more documents. Further, in a case where the relation information is a mathematical expression, the inference unit 104A can infer a relation by transformation of the mathematical expression. In this case, the extraction unit 101A may include, in a prompt in extracting relation information from documents, a sentence that explicitly instructs extraction of a mathematical expression.

Further, the relation information is not limited to a mathematical expression, but may be, for example, text. In this case, the inference unit 104A may inputs, to the language model 111A, the first matter, the second matter, and each relation information (the first relation information and the second relation information that are described above), and, then, cause the language model 111A to infer the relation between the first matter and the second matter which is derived from those pieces of relation information. For example, it is assumed that text extracted as the first relation information is “the period in which an appropriate body weight is maintained is proportional to the amount of investment for weight management”, and text extracted as the second relation information is “the reduction rate of medical expenses is proportional to the period in which an appropriate body weight is maintained”. In this case, the extraction unit 101A inputs these pieces of text to the language model 111A. Consequently, the extraction unit 101A can obtain, for example, a result of inference “the period in which an appropriate body weight is maintained is proportional to the reduction rate of medical expenses”.

### (Reception of Question and Generation of Answer)

The following description will discuss the reception unit 105A and the answer generation unit 106A. The reception unit 105A receives input of a question from a user. For example, the reception unit 105A may receive input of a question via the communication unit 12A or via the input unit 13A. Further, the question may be inputted in text or in voice. In the latter case, the reception unit 105A may carry out processing after converting, into text, inputted voice.

The answer generation unit 106A generates an answer to the question with use of the logic model 112A. A method of generating the answer is not particularly limited. For example, the answer generation unit 106A may generate an answer with use of the language model 111A. In this case, the answer generation unit 106A may generate a prompt which includes the question that has been received by the reception unit 105A and the logic model 112A and which instructs generation of the answer to the question on the basis of the logic model 112A. The answer generation unit 106A can generate the answer based on the logic model 112A by inputting such a prompt to the language model 111A.

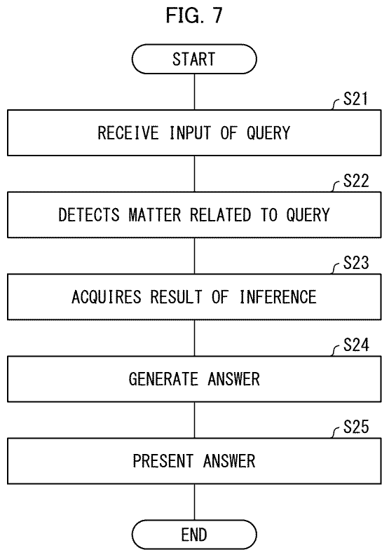

Instead of inputting the logic model 112A itself to the language model 111A, the answer generation unit 106A may detect a matter that is related to the question of the user among matters that are included in the logic model 112A. Then, the extraction unit 101A may input, to the language model 111A, the matter detected. This example will be described later with reference to FIG. 7.

The answer generated by the answer generation unit 106A is presented to the user by the presentation unit 107A. Note that a person who inputted the question and a person to whom the answer is to be presented may be identical to each other or different from each other. Further, the answer may be presented by display output of text, or by voice output.

As described above, the information processing apparatus 1A includes the reception unit 105A that receives input of a question, the answer generation unit 106A that generates an answer to the question with use of the logic model 112A, and the presentation unit 107A that presents the answer generated. This makes it possible to obtain, in addition to the example advantage yielded by the information processing apparatus 1, an example advantage of making it possible to answer the question from the user on the basis of a logical relation of matters described in pieces of content which are targets of analysis.

For example, it is assumed that in a case where the logic model 112A-1 of FIG. 5 is generated and recorded in the storage unit 11A, the reception unit 105A receives a question “what can a person do in order to extend healthy life expectancy?” It should be noted here that in the logic model 112A-1, the matter M41 is associated with the matter M12 regarding the “healthy life expectancy”. Accordingly, the answer generation unit 106A can generate, with use of the logic model 112A-1, an answer including the matter M41 (for example, “it is effective to record the number of daily steps”).

Moreover, for example, it is assumed that in a case where the logic model 112A-2 of FIG. 5 is generated and recorded in the storage unit 11A, the reception unit 105A receives a question “what effect can be expected in a case where a person decides to go weekly to a fitness club for weight management?” It should be noted here that in the logic model 112A-2, the matter M62 is associated with the matter M51 regarding the “weight management”. Therefore, the answer generation unit 106A can generate, with use of the logic model 112A-2, an answer including the matter M62 (for example, “reduction in medical expenses can be expected”).

Alternatively, the answer generation unit 106A may generate an answer in consideration of a result of inference by the inference unit 104A. In this case, for example, the answer generation unit 106A can generate the following answer or the like: “given that the amount of investment is x yen in a case where a person goes to a fitness club for one year, an amount of expected reduction in medical expenses is y yen”.

Alternatively, the answer generation unit 106A may generate an answer in consideration of attribute information that indicates a user's attribute. Note that the “user” here is a person who makes a question or a person to whom the answer is to be presented. The attribute to be considered is arbitrary, and may be, for example, attribute information that indicates age, gender, occupation, personality, past action history, and/or the like of the user. Further, the attribute information of the user may be inputted in advance or a part of the question that has been received by the reception unit 105A may be used as the attribute information.

For example, the answer generation unit 106A may generate, with use of attribute information that indicates an occupation of the user, an answer having content that corresponds to the occupation. In a specific example, in a case where a question inputted is “tell a recommended side business”, the answer generation unit 106A may generate a prompt which includes the question inputted and the logic model 112A and which indicates the occupation of the user, and may input the prompt to the language model 111A. This makes it possible to generate an answer that is based on the logic model 112A and that indicates a side business corresponding to the occupation of the user.

### (Process Flow: Analysis Method)

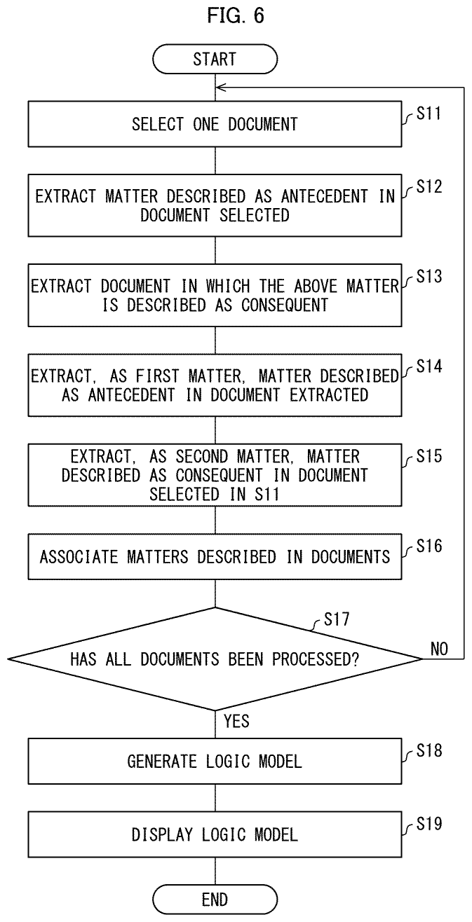

A flow of a series of processes carried out by the information processing apparatus 1A will be described with reference to FIG. 6. FIG. 6 is a flowchart illustrating the flow of the series of process carried out by the information processing apparatus 1A. The flow of FIG. 6 includes steps of an analysis method in accordance with the present example embodiment.

In S11, the extraction unit 101A selects one document from among a plurality of documents which are analysis targets. Although any method can be used for selecting the document, a selected document is not to be selected again. Note that a document that is a candidate of selection may be designated in advance. For example, a specific DB may be designated, as in the example of FIG. 4. In this case, in S11, the extraction unit 101A selects one document from among documents that are recorded in the DB designated.

In S12 (extraction process), from the document (corresponding to the first content described above) obtained in S11, the extraction unit 101A extracts, with use of the language model 111A, a matter described as an antecedent in the document.

In S13, the extraction unit 101A extracts, with use of the language model 111A, a document (corresponding to the second content described above) in which the matter extracted in S12 is described as a consequent from among the plurality of documents which are analysis targets. Note that in a case where there is no document in which the matter extracted in S12 is described as a consequent, that is, no second content, among the plurality of documents which are analysis targets, the series of processes proceeds to step S17 without carrying out processes in steps S13 to S16.

In S14 (extraction process), the extraction unit 101A extracts, as the first matter, a matter described as an antecedent in the document extracted in S13, that is, in the second content. As described above, the language model 111A is also used for extraction of the first matter.

In S15 (extraction process), the extraction unit 101A extracts, as the second matter, a matter described as a consequent in the document selected in S11, that is, in the first content. As described above, the language model 111A is also used for extraction of the second matter. Note that the process of S15 may be carried out earlier than S14 or in parallel with S14.

In S16 (analysis process), the analysis unit 102A carries out association of those matters described in the documents. Specifically, the analysis unit 102A associates (i) the first matter (the matter extracted in S14) described as an antecedent in a document in which an intermediate matter is described as a consequent, that is, in the second content and (ii) the second matter (the matter extracted in S15) described as a consequent in the document in which the intermediate matter is described as an antecedent, that is, in the first content. Note that the process of S16 may be carried out later than in S17 described below.

In S17, the extraction unit 101A determines whether or not all of the plurality of documents which serve as the analysis targets have been subjected to the processes from S11 and steps subsequent to S11. In a case where a result of determination in S17 is NO, the series of processes returns to S11, and the extraction unit 101A selects a document to be processed next. On the other hand, in a case where the result of determination is YES in S17, the process of the information processing apparatus 1A proceeds to S18.

In S18, the model generation unit 103A generates, on the basis of a result of association in S16, the logic model 112A that indicates a logical relation between matters described in the plurality of documents which are analysis targets. Note that in a case where the logic model 112A has already been generated, the model generation unit 103A updates the logic model 112A that is existing.

In S19, the presentation unit 107A causes a display apparatus (which may be provided in the information processing apparatus 1A or in another apparatus) to display the logic model 112A that has been generated or updated in S18. As a result, the series of processes in FIG. 6 ends.

### (Process Flow: Reception of Question and Presentation of Answer)

A flow of a series of processes in a case where the information processing apparatus 1A receives a question and presents an answer will be described with reference to FIG. 7. FIG. 7 is a flowchart illustrating a flow of the series of processes in receiving a question and presenting an answer.

In S21, the reception unit 105A receives input of a question from a user. How to receive the question is not particularly limited. For example, the reception unit 105A may receive input of the question via the communication unit 12A or via the input unit 13A.

In S22, the answer generation unit 106A detects, from the logic model 112A, a matter related to the question received in S21. For example, the answer generation unit 106A may generate a prompt which includes the question received and the logic model 112A and which instructs to select, from the logic model 112A, a matter related to the question. Then, the answer generation unit 106A may input the prompt generated to the language model 111A. Thus, the answer generation unit 106A can detect, on the basis of an output of the language model 111A, a matter related to the question received in S21. Further, in the logic model 112A, the answer generation unit 106A also detects, as a matter related to the above question, a matter associated with the matter detected as described above.

For example, it is assumed that in a case where the logic model 112A-1 illustrated in FIG. 5 is stored in the storage unit 11A, a question “because I am diagnosed to have hypertension, I'm thinking of reconsidering my lifestyle. Is there any good way?” is received. In this case, the answer generation unit 106A can detect, from the logic model 112A-1, the matter M22 as a matter related to the question by search as described above. Then, in the logic model 112A-1, the answer generation unit 106A can also detect, as matters related to the question, the matters M21, M11, M42, and M41 that are associated with the matter M22. Note that the intermediate matter may be excluded from a detection target. In such a case, only the matter M41 is detected as a matter related to the matter M21.

In S23, the answer generation unit 106A acquires a result of inference by the inference unit 104A which is related to the matter detected in S22. Inference by the inference unit 104A may be carried out in advance (e.g., after S16 in the flow of FIG. 6) or after S22 and before S23. Further, in addition to the result of inference by the inference unit 104A, the answer generation unit 106A may also acquire relation information that is related to the matter detected in S22. Extraction of the relation information may be carried out in advance in the same manner as the inference by the inference unit 104A, or may be carried out after S22 and before S23.

In S24, the answer generation unit 106A generates the answer to the question received in S21. More specifically, the answer generation unit 106A may generate a prompt which includes the question received in S21, the matter detected in S22, and the result of inference acquired in S23 and which instructs to generate the answer to the question on the basis of the matter and the result of inference. Then, the answer generation unit 106A can generate the answer to the question by inputting such a prompt to the language model 111A. Further, in a case where the answer generation unit 106A has acquired the relation information in S23, the answer generation unit 106A may also include, in the prompt, the relation information that has been acquired.

In S25, the presentation unit 107A presents, to a user, the answer that has been generated in S24. As a result, the series of processes illustrated in FIG. 7 ends. Note that the series of processes may be configured to return to S21 after S25 and receive an additional question.

Further, extraction and association of described matters from documents which are analysis targets may be carried out after reception of a question. In this case, the extraction unit 101A retrieves, from the documents which are analysis targets, a matter asked in the question received, and sets, as the above-described first matter or second matter, the matter acquired by this retrieval and extracts the second matter related to the first matter or the first matter related to the second matter. Thus, the answer generation unit 106A can generate an answer based on the second matter or the first matter that has been extracted.

For example, it is assumed that a question “because I am diagnosed to have hypertension, I'm thinking of reconsidering my lifestyle. Is there any good way?” is received. In a case where a question that asks for an “antecedent” such as a strategy or condition is received in this way, the extraction unit 101A tries to extract a document in which “hypertension” is described as a consequent, and extracts the document D2. Then, the extraction unit 101A extracts the matter M22 “hypertension improves”, which is described as a consequent in the document D2, and set this matter as the second matter. Next, the extraction unit 101A tries to extract a document in which the matter M21 described as an antecedent that corresponds to the matter M22 in the document D2 is described as a consequent, and thus detects the document D4. Then, the extraction unit 101A extracts, as the first matter, the matter M41 “the number of daily steps is recorded” which is described as an antecedent in the document D4. Thus, the analysis unit 102A can associate the matter M41 and the matter M22 with each other. Thus, the answer generation unit 106A can generate an answer based on this association (e.g., an answer which recommends that “the number of daily steps is recorded”).

Moreover, for example, it is assumed that a question “what effect can be expected in a case where I decide to go weekly to a fitness club for weight management?” is received. In a case where a question that asks in this way about a “consequent” such as an effect or a result is received, the extraction unit 101A tries to extract a document in which “weight management” is described as an antecedent, and extracts the document D5. Then, the extraction unit 101A extracts the matter M51 “amount of investment for weight management”, which is described as an antecedent in the document D5, and sets this matter as the first matter. Next, the extraction unit 101A tries to extract a document in which the matter M52 described as a consequent that corresponds to the matter M51 in the document D5 is described as an antecedent, and thus detects the document D6. Then, the extraction unit 101A extracts, as the second matter, the matter M62 “reduction rate of medical expenses”, which is described as a consequent in the document D6. Thus, the analysis unit 102A can associate the matter M51 and the matter M62 with each other. Then, the answer generation unit 106A can generate an answer based on this association (e.g., an answer which describes that “reduction of medical expenses” can be expected).

### Example 2 of Extraction and Association: Start from Extraction of Consequent

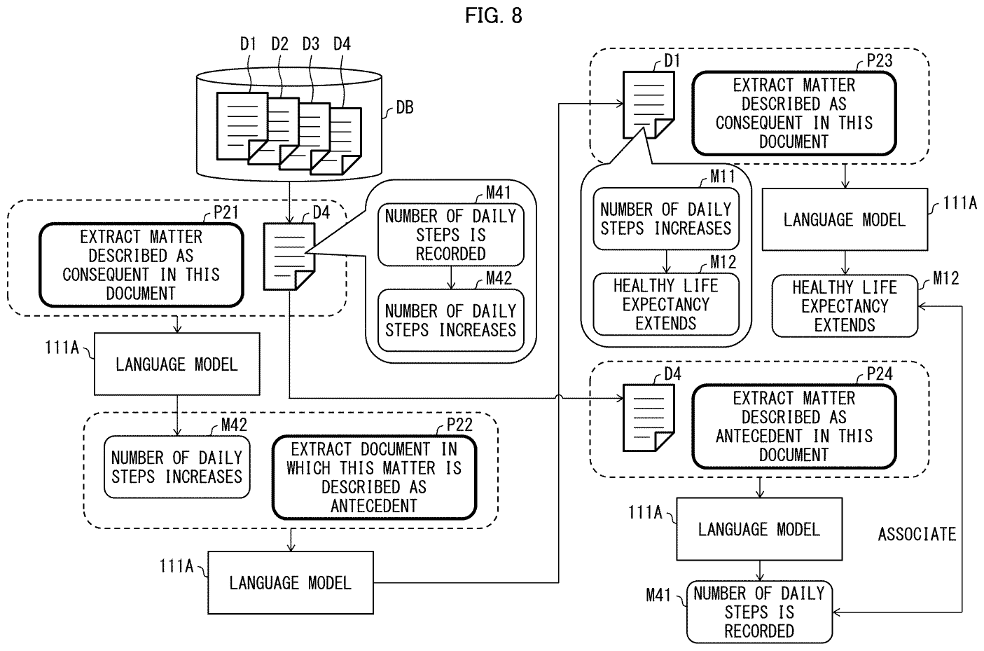

In the example of FIG. 4, after documents are selected one by one from among the documents D1 to D4 which are recorded in the DB, a matter described as an antecedent in the document selected is extracted. However, a matter described as a consequent in the document selected may be extracted. This will be described with reference to FIG. 8. FIG. 8 is a diagram illustrating another example of extraction and association of matters described in documents. Note that since matters described in documents D1 to D4 are the same as those in the example of FIG. 4, description of the matters described are not repeated.

In the example of FIG. 8, the extraction unit 101A reads out documents D1 to D4 one by one which are recorded in the DB, and extracts, from each of the documents thus read out, a matter described as a consequent in the document. For example, as illustrated in FIG. 8, the extraction unit 101A may input, to the language model 111A, the document D4 and a fixed prompt P21 that says “extract a matter described as a consequent in this document”. This makes it possible to extract the matter M42 from the document D4 as illustrated. Note that the extraction unit 101A may extract, from a single document, a plurality of matters each described as a consequent in the document.

Next, the extraction unit 101A extracts a document in which the matter extracted as described above is described as an antecedent. For example, as illustrated in FIG. 8, the extraction unit 101A may input, to the language model 111A, the matter M42 and a fixed prompt P22 “extract a document in which this matter is described as an antecedent”. Further, the extraction unit 101A may specify, as extraction candidates, the documents D1 to D4 which are recorded in the DB. As a result, in the example of FIG. 8, the document D1 is extracted. Note that in a case where a plurality of matters described as antecedents are extracted from the document D4, the extraction unit 101A tries to extract, for each of the matters extracted, a document in which the matter is described as an antecedent. Further, in a case where no corresponding document is extracted, the extraction unit 101A reads out another document from the DB and extracts, from the another document, a matter described as a consequent in the document.

Next, the extraction unit 101A inputs, to the language model 111A, the document D1 that has been extracted as described above and a prompt P23 that instructs extraction of a matter described as a consequent in the document D1. Thus, the extraction unit 101A causes the language model 111A to extract a matter described as a consequent in the document D1. This makes it possible to extract the matter M12 from the document D1 as illustrated in FIG. 8.

Further, the extraction unit 101A inputs, to the language model 111A, the document D4 and a prompt P24 that instructs extraction of a matter described as an antecedent in the document D4. Thus, the extraction unit 101A causes the language model 111A to extract a matter described as an antecedent in the document D4. This makes it possible to extract the matter M41 from the document D4 as illustrated in FIG. 8.

The analysis unit 102A associates the matter M41 that has been extracted from the document D4 as described above and the matter M12 that has been extracted from the document D1 as described above with each other. This leads to findings that if “the number of daily steps is recorded”, “healthy life expectancy extends”, as in the example of FIG. 4.

As described above, with use of the language model 111A, the extraction unit 101A may: (1) extract a matter (the matter M42 in the example of FIG. 8) described as a consequent in first content (the document D4 in the example of FIG. 8) that is one of a plurality of pieces of content which are analysis targets; (2) extract, from among the plurality of pieces of content, second content (the document D1 in the example of FIG. 8) in which the matter extracted is described as an antecedent; (3) extract, as the second matter, a matter (the matter M12 in the example of FIG. 8) described as a consequent in the second content; and (4) extract, as the first matter, a matter (M11 in the example of FIG. 8) described as an antecedent in the first content. This makes it possible to obtain an example advantage of making it possible to derive new findings by logically associating matters described in a plurality of pieces of content.

In the case of starting from extraction of a consequent as illustrated in FIG. 8, a flow of a series of processes is the same as that in FIG. 6. However, in the case of starting from extraction of a consequent, a matter described as a “consequent” in a selected document is extracted in S12, and a document in which the matter extracted in S12 is described as an “antecedent” is extracted in S13. Then, in S14, a matter described as a “consequent” in the document extracted in S13 is extracted as the “second matter”, and in S15, a matter described as an “antecedent” in a document selected in S11 is extracted as the “first matter”.

### Example 3 of Extraction and Association: Extraction of Antecedent and Consequent from Each Document

With use of the language model 111A, the extraction unit 101A may extract, from each of a plurality of pieces of content which are analysis targets, a matter described as an antecedent in the content and a matter described as a consequent that corresponds to the matter described as the antecedent. In this case, the analysis unit 102A may specify the first matter and the second matter among extracted matters by specifying, as an intermediate matter, a matter that is described as an antecedent in a certain piece of content and that is also described as a consequent in another piece of content among the extracted matters. Then, the analysis unit 102A only needs to associate the first matter and the second matter which are specified with each other. With a process like this, it is possible to obtain an example advantage of making it possible to derive new findings by logically associating matters described in a plurality of pieces of content.

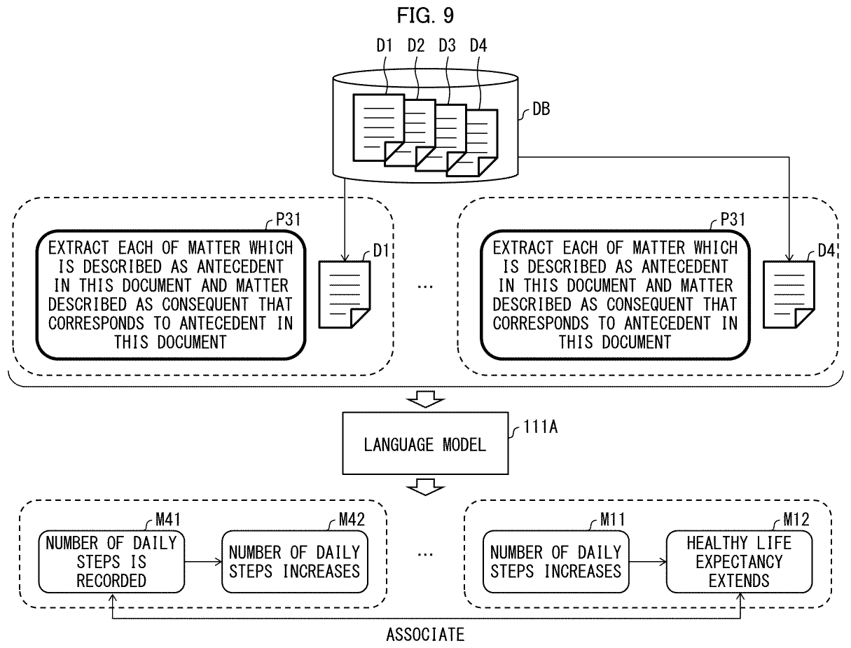

The above process will be described with reference to FIG. 9. FIG. 9 is a diagram illustrating still another example of extraction and association of matters described in documents. In the example of FIG. 9, the extraction unit 101A reads out the documents D1 to D4 one by one which are recorded in the DB, and extracts, from each of the documents thus read out, a matter described as an antecedent and a matter described as a consequent in the document. For example, as illustrated in FIG. 9, the extraction unit 101A may perform, for each of the documents D1 to D4, a process of inputting, to the language model 111A, the document read out and a fixed prompt P31 “extract each of a matter which is described as an antecedent and a matter which is described as a consequent that corresponds to the antecedent in this document”. This makes it possible to extract, as illustrated in FIG. 9, the matter described as an antecedent and the matter described as a consequent in each of the documents D1 to D4.

Then, the analysis unit 102A specifies the first matter and the second matter among matters extracted as described above, and associates the first matter and the second matter which are specified with each other. As described above, the first matter refers to a matter described as an antecedent in content in which an intermediate matter is described as a consequent and the second matter is a matter described as a consequent in content in which the intermediate matter is described as an antecedent. Thus, the analysis unit 102A may specify the intermediate matter from among the matters extracted by the extraction unit 101A. Further, the analysis unit 102A may set, as the first matter, a matter described as an antecedent in content in which the intermediate matter specified is described as a consequent and set, as the second matter, a matter described as a consequent in content in which the intermediate matter specified is described as an antecedent. Then, the analysis unit 102A may associate the first matter and the second matter with each other.

Note that a method of specifying the intermediate matter is not particularly limited, and for example, the language model 111A may be caused to specify the intermediate matter. In this case, the analysis unit 102A may generate a prompt that instructs to extract matters having the same content among the matters extracted by the extraction unit 101A, and input the prompt to the language model 111A. Then, the analysis unit 102A can specify, as the intermediate matter, a matter that is described as an antecedent in a certain piece of content and that is also described as a consequent in another piece of content among the matters extracted.

In the example of FIG. 9, since the content of the matter M42 is identical to the content of the matter M11, these matters are each specified as the intermediate matter. Then, through this intermediate matter, the matter M41 extracted from the document D4 and the matter M12 extracted from the document D1 are associated with each other. This leads to findings that if “the number of daily steps is recorded”, “healthy life expectancy extends”, as in the example of FIG. 4.

### (Process Flow: Analysis Method Corresponding to FIG. 9)

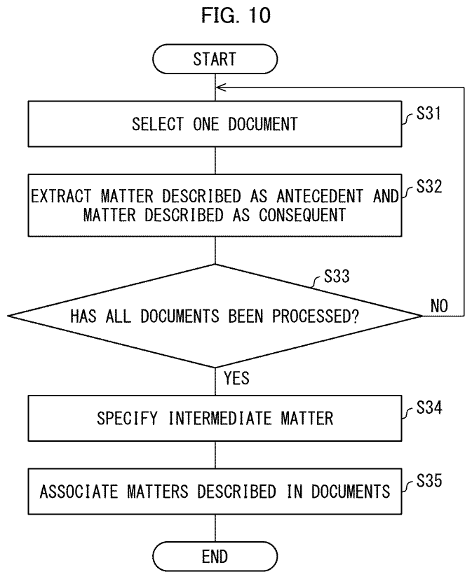

As described above with reference to FIG. 9, after from each of a plurality of pieces of content which are analysis targets, a matter which is described as an antecedent in the content and a matter which is described as a consequent that corresponds to the matter described as the antecedent are extracted, matters may be associated with each other. A flow of a series of processes carried out by the information processing apparatus 1A will be described with reference to FIG. 10. FIG. 10 is a flowchart illustrating another example of the flow of the series of process carried out by the information processing apparatus 1A. The flow of FIG. 10 also includes steps of the analysis method in accordance with the present example embodiment, as in the flow of FIG. 6.

Note that processes of S31 and S33 in FIG. 10 are the same as those in S11 and S17 in FIG. 6, and therefore, the description thereof will not be repeated here. Further, although the flow of FIG. 10 does not include processes of generating and presenting the logic model 112A, the flow of FIG. 10 may also include the processes of generating and presenting the logic model 112A.

In S32 (extraction process), with use of the language model 111A, the extraction unit 101A extracts, from a document acquired in S31, a matter described as an antecedent and a matter described as a consequent that corresponds to the matter described as the antecedent in the document. Note that the extraction unit 101A may extract, from a single document, a plurality of sets of a matter described as an antecedent and a matter described as a consequent.

In S34, the analysis unit 102A specifies an intermediate matter from among matters that are described in a plurality of documents which are analysis targets and that are extracted by repeating the processes of S31 to S33. Note that the analysis unit 102A may specify a plurality of intermediate matters. On the other hand, in a case where there is no intermediate matter among those described matters extracted, the series of processes of FIG. 10 ends.

In S35 (analysis process), the analysis unit 102A associates the matters described in the documents. Specifically, the analysis unit 102A associates (i) the first matter described as an antecedent in a document in which the intermediate matter specified in S34 is described as a consequent and (ii) the second matter described as a consequent in the document in which the intermediate matter is described as an antecedent. As a result, the series of processes of FIG. 10 ends. Note that in a case where a plurality of intermediate matters are specified in S34, association is carried out in S35 for each of the intermediate matters.

### Example 4 of Extraction and Association: Example 1 in which Document in which Intermediate Matter is Described is Extracted

With use of the language model 111A, the extraction unit 101A may (1) extract, from a plurality of pieces of content, a piece of content in which a matter described as an antecedent in another piece of content is described as a consequent, that is, second content in which an intermediate matter is described; (2) extract, as the first matter, a matter described as an antecedent in the piece of content that has been extracted; and (3) extract, as the second matter, a matter which is described as a consequent in the another piece of content in which the matter described as a consequent in the piece of content that has been extracted is described as an antecedent, that is, in first content in which the intermediate matter is described. With a process like this, it is possible to obtain an example advantage of making it possible to derive new findings by logically associating matters described in a plurality of pieces of content.

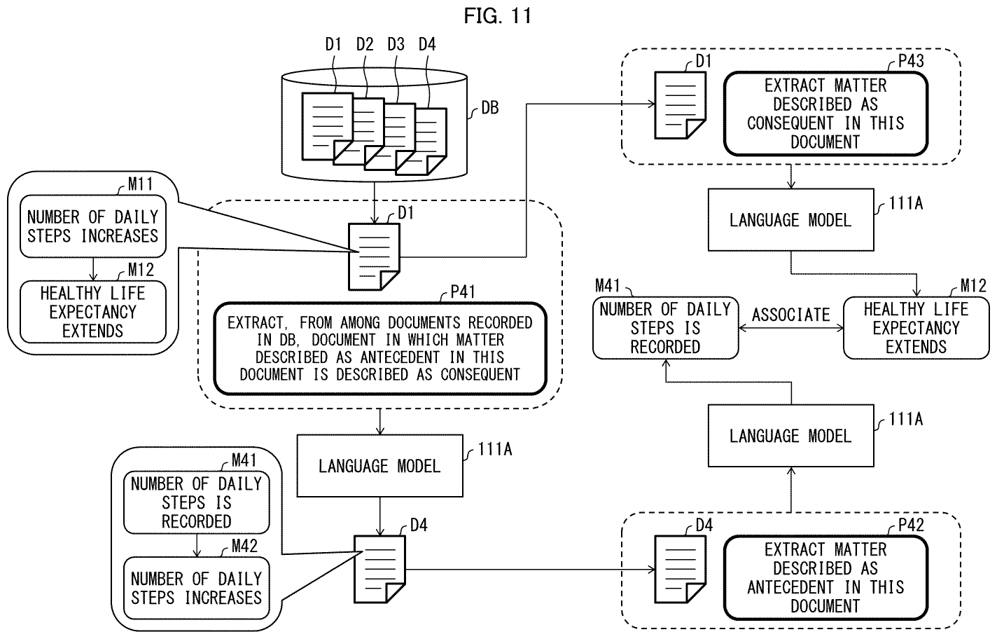

The above process will be described with reference to FIG. 11. FIG. 11 is a diagram illustrating still another example of extraction and association of matters described in documents. In the example of FIG. 11, the extraction unit 101A reads out the documents D1 to D4 one by one which are recorded in the DB, and extracts, from each of the documents thus read out, a document in which a matter that is described as an antecedent in the document read out is described as a consequent. For example, as illustrated in FIG. 11, the extraction unit 101A may input, to the language model 111A, the document read out and a fixed prompt P41 “extract, from among documents recorded in a DB, a document in which a matter described as an antecedent in this document is described as a consequent”. This makes it possible that as illustrated in FIG. 11, in a case where the document read out is the document D1, it is possible to extract the document D4 in which the matter M42 that has the same content as the matter M11 described as an antecedent in the document D1 is described as a consequent. Since the matters M11 and M42 are each an intermediate matter, the document D4 in this example corresponds to the above-described second content, and the document D1 corresponds to the above-described first content.

Next, the extraction unit 101A extracts, as the first matter, a matter described as an antecedent in the document D4 extracted, that is, in the second content, and also extracts, as the second matter, a matter described as a consequent in the document D1 read out from the DB, that is, the first content.

More specifically, as illustrated in FIG. 11, the extraction unit 101A inputs, to the language model 111A, the document D4 extracted and a prompt P42 that instructs extraction of a matter described as an antecedent in the document D4. Thus, the extraction unit 101A causes the language model 111A to extract a matter described as an antecedent in the document D4. This makes it possible to extract, as the first matter, the matter M41 described in the document D4, as illustrated in FIG. 11.

Further, as illustrated in FIG. 11, the extraction unit 101A inputs, to the language model 111A, the document D1 that is read out and a prompt P43 that instructs extraction of a matter described as a consequent in the document D1. Thus, the extraction unit 101A causes the language model 111A to extract a matter described as a consequent in the document D1. This makes it possible to extract, as the second matter, the matter M12 described in the document D1, as illustrated in FIG. 11.

The analysis unit 102A associates the matter M41 that has been extracted from the document D4 as described above and the matter M12 that has been extracted from the document D1 as described above with each other. This leads to findings that if “the number of daily steps is recorded”, “healthy life expectancy extends”, as in the example of FIG. 4 and the like.

### (Process Flow: Analysis Method Corresponding to FIG. 11)

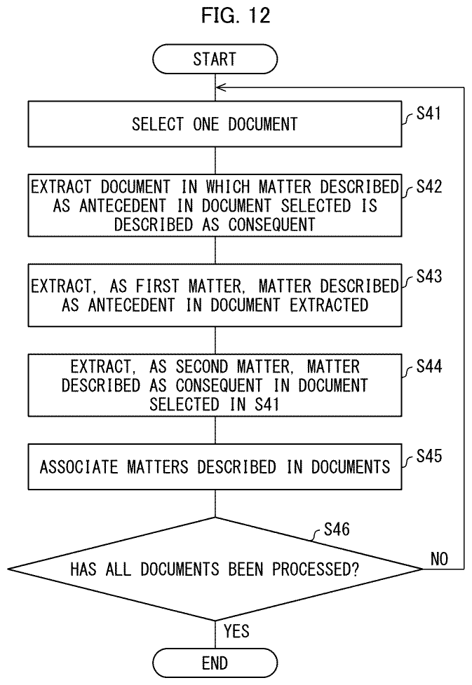

As described above with reference to FIG. 11, the language model 111A may be used to extract documents in which an intermediate matter is described, then extract the first and second matters, and associate these matters with each other. A flow of a series of processes carried out by the information processing apparatus 1A in this case will be described with reference to FIG. 12. FIG. 12 is a flowchart illustrating another example of the flow of the series of processes carried out by the information processing apparatus 1A. The flow of FIG. 12 also includes steps of the analysis method in accordance with the present example embodiment, as in the flow of FIG. 6.

Note that the flow of FIG. 12 and the flow of FIG. 6 are the same except that the processes of S12 and S13 in the latter are replaced with a process of S42. Therefore, S42 will be mainly discussed here. Further, although the flow of FIG. 12 does not include processes of generating and presenting the logic model 112A, the flow of FIG. 12 may also include the processes of generating and presenting the logic model 112A.

In S42 (extraction process), with use of the language model 111A, the extraction unit 101A extracts, from a plurality of documents which are analysis targets, a document in which a matter described as an antecedent in a document selected in S41 is described as a consequent, that is, second content. Note that in S42, the extraction unit 101A may extract a plurality of documents.

In S43 (extraction process), the extraction unit 101A extracts, as the first matter, a matter described as an antecedent in the document extracted in S42, that is, in the second content. Further, in S44 (extraction process), the extraction unit 101A extracts, as the second matter, a matter described as a consequent in the document selected in S41, that is, in the first content. Then, in S45 (analysis process), the analysis unit 102A associates the first matter extracted in S43 and the second matter extracted in S44 with each other.

### Example 5 of Extraction and Association: Example 2 in which Document in which Intermediate Matter is Described is Extracted

With use of the language model 111A, the extraction unit 101A may (1) extract, from a plurality of pieces of content, a piece of content in which a matter described as a consequent in another piece of content is described as an antecedent, that is, first content in which an intermediate matter is described; (2) extract, as the second matter, a matter described as a consequent in the piece of content that has been extracted; and (3) extract, as the first matter, a matter which is described as an antecedent in the another piece of content in which the matter described as an antecedent in the piece of content that has been extracted is described as a consequent, that is, in second content in which the intermediate matter is described. With a process like this, it is possible to obtain an example advantage of making it possible to derive new findings by logically associating matters described in a plurality of pieces of content.

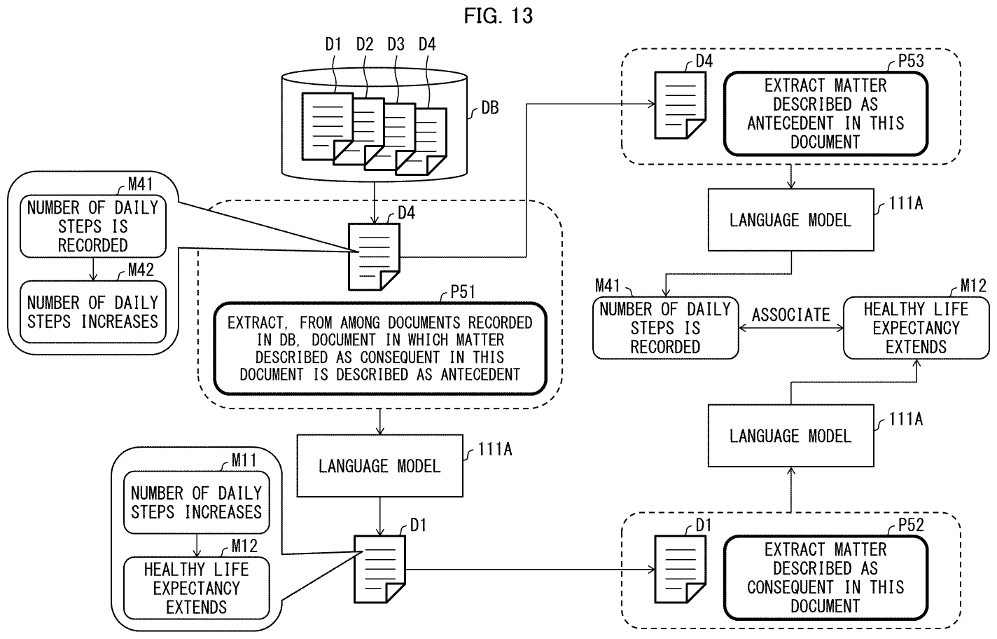

The above process will be described with reference to FIG. 13. FIG. 13 is a diagram illustrating still another example of extraction and association of matters described in documents. In the example of FIG. 13, the extraction unit 101A reads out the documents D1 to D4 one by one which are recorded in the DB, and extracts, from each of the documents thus read out, a document in which a matter that is described as a consequent in the document read out is described as an antecedent. For example, the extraction unit 101A may input, to the language model 111A, as illustrated in FIG. 13, the document read out and a fixed prompt P51 “extract, from among documents recorded in a DB, a document in which a matter described a consequent in this document is described as an antecedent”. This makes it possible that as illustrated in FIG. 13, in a case where the document read out is the document D4, it is possible to extract the document D1 in which the matter M11 that has the same content as the matter M42 described as a consequent in the document D4 is described as an antecedent. Since the matters M42 and M11 are each an intermediate matter, the document D1 in this example corresponds to the above-described first content, and the document D4 corresponds to the above-described second content.

Next, the extraction unit 101A extracts, as the second matter, a matter described as a consequent in the document D1 extracted, that is, in the first content, and also extracts, as the first matter, a matter described as an antecedent in the document D4 read out from the DB, that is, the second content.

More specifically, as illustrated in FIG. 13, the extraction unit 101A inputs, to the language model 111A, the document D1 that is extracted and a prompt P52 that instructs extraction of a matter described as a consequent in the document D1. Thus, the extraction unit 101A causes the language model 111A to extract a matter described as a consequent in the document D1. This makes it possible to extract, as the second matter, the matter M12 described in the document D1, as illustrated in FIG. 13.

Further, as illustrated in FIG. 13, the extraction unit 101A inputs, to the language model 111A, the document D4 that is read out and a prompt P53 that instructs extraction of a matter described as an antecedent in the document D4. Thus, the extraction unit 101A causes the language model 111A to extract a matter described as an antecedent in the document D4. This makes it possible to extract, as the first matter, the matter M41 described in the document D4, as illustrated in FIG. 13.

The analysis unit 102A associates the matter M41 that has been extracted from the document D4 as described above and the matter M12 that has been extracted from the document D1 as described above with each other. This leads to findings that if “the number of daily steps is recorded”, “healthy life expectancy extends”, as in the example of FIG. 4 and the like.

The flow of the process (analysis method) in the example of FIG. 13 is the same as that in the example of FIG. 11 (see FIG. 12). However, in the process in the example of FIG. 13, in S42, a document in which a matter described as “consequent” in the document selected is described as an “antecedent” is extracted. Further, in S43, a matter described as a “consequent” in the document extracted in S42 is extracted as the “second matter”. Further, in S44, a matter described as an “antecedent” in the document selected in S41 is extracted as a “first matter”.

### (Use as Search Apparatus for Document)

The information processing apparatus 1A can be used as a search apparatus for a document(s). In this case, the user inputs, to the information processing apparatus 1A, information that indicates a search target. The information that indicates a search target may be, for example, a document including a description related to the document which a user would like to retrieve, or a sentence (text data) indicating the search target.

For example, it is assumed that a user inputs a document as information that indicates a search target. In this case, the extraction unit 101A specifies, as an intermediate matter, a matter described as an antecedent or a consequent in the document inputted, to extract, from among a plurality of documents which are targets for search, a document in which the intermediate matter is described. Then, the presentation unit 107A presents, to a user, the document that is extracted by the extraction unit 101A.

The method described in FIG. 4, 8, 9, 11 or 13 can be applied to extraction of the document(s). For example, in a case where the method described in FIG. 4 is applied, the extraction unit 101A extracts a matter described as an antecedent in a document inputted. Then, the extraction unit 101A extracts a document in which the matter extracted is described as a consequent. Further, in a case where the method described in FIG. 8 is applied, the extraction unit 101A extracts a matter described as a consequent in a document inputted. Then, the extraction unit 101A extracts a document in which the matter extracted is described as an antecedent.

Further, in a case where the method described in FIG. 9 is applied, the extraction unit 101A extracts a matter described as an antecedent and a matter described as a consequent in a document inputted. Further, the extraction unit 101A also extracts, from a plurality of documents which are targets for search, a matter described as an antecedent and a matter described as a consequent in those documents. Then, the extraction unit 101A extracts, from the plurality of documents which are targets for search, (i) a document in which a matter described as an antecedent in the document inputted is described as a consequent and/or (ii) a matter described as a consequent in the document inputted is described as an antecedent.

Further, in a case where the method illustrated in FIG. 11 is applied, the extraction unit 101A extracts, from a plurality of documents which are targets for search, a document in which a matter described as an antecedent in the document inputted is described as a consequent. Similarly, in a case where the method illustrated in FIG. 13 is applied, the extraction unit 101A extracts, from a plurality of documents which are targets for search, a document in which a matter described as a consequent in the document inputted is described as an antecedent.

It is assumed here that a user inputs text that indicates a search target. In this case, the extraction unit 101A extracts, from a plurality of documents which are targets for search, a document in which a matter that is indicated in the text inputted is described as an antecedent or a consequent. Then, the extraction unit 101A specifies, as an intermediate matter, a matter that is described, in the document extracted, as an antecedent or consequent that corresponds to the matter indicated in the text, to extract a document in which the intermediate matter is described.

For example, it is assumed that the above text indicates user's question “what effect is expected by intake of a supplement s?” In a case where a question that asks about a “consequent” such as an effect or a result is received in this way, the extraction unit 101A tries to extract a document in which “a supplement s is taken in” is described as an antecedent, and extracts a document. Then, the extraction unit 101A specifies, as the intermediate matter, a matter (for example, “the quality of sleep improves”) which is described, in the document extracted, as a consequent that corresponds to the matter “a supplement s is taken in”, to extract a document in which the intermediate matter is described as an antecedent. Accordingly, extracted is, for example, a document which describes that if the quality of sleep improves, work efficiency increases or the like. As a result, the presentation unit 107A presents such a document to a user. This makes it possible to give findings that it is possible to expect an increase in work efficiency if the supplement s is taken in.

Furthermore, for example, in the case of receiving a question that asks about an “antecedent” such as a strategy or condition, the extraction unit 101A may extract a document in which a matter indicated in the above text is described as a consequent. Then, the extraction unit 101A specifies, as the intermediate matter, the matter described, in the document extracted, as an antecedent corresponding to the matter described in the text, to extract a document in which the intermediate matter is described as a consequent.

As described above, the information processing apparatus 1A includes: an extract unit 101A that, provided that (i) an intermediate matter is a matter that is described as an antecedent in a certain piece of content among a plurality of pieces of content which are targets and that is also described as a consequent in another piece of content among the plurality of pieces of content which are targets, (ii) content in which the intermediate matter is described a consequent is defined as first content, and (iii) content in which the intermediate matter is described an antecedent is defined as second content, extracts the first content and/or the second content with use of a language model 111A which has been trained by machine learning; and a presentation unit 107A that presents the content extracted by the extraction unit 101A. This yields an example advantage of making it possible to support use of various types of content.

Note that “a plurality of pieces of content which are targets” in the above configuration can include content inputted by a user for search in addition to pieces of content that are targets for search. In this case, the content inputted by the user for search is the first or second content. Then, in a case where the content inputted by the user for search is the first content, the extraction unit 101A extracts the second content from the pieces of content which are targets for search. On the other hand, in a case where the content inputted by the user for search is the second content, the extraction unit 101A extracts the first content from the pieces of content which are targets for search.

### [Variations]

The processes described in the foregoing example embodiments may be carried out by any subject, which is not limited to the foregoing examples. For example, a system having functions similar to those of the information processing apparatus 1, 1A can be constructed by a plurality of apparatuses that can communicate with each other. Further, the execution subjects of the processes illustrated in the flowcharts illustrated in FIGS. 6, 7, 10, and 12 may be one apparatus (also referred to as a processor) or a plurality of apparatuses (also referred to as a processor).

### Software Implementation Example

Some or all of the functions of the information processing apparatus 1, 1A can be realized by hardware such as an integrated circuit (IC chip), or can be realized by software.

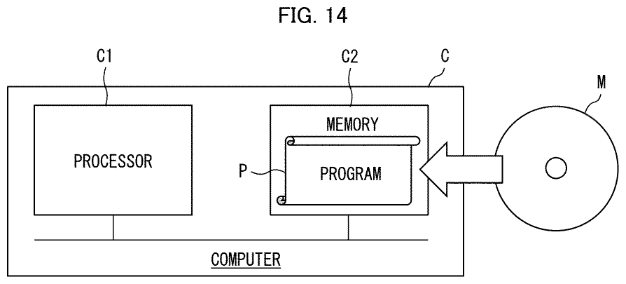

In the latter case, the information processing apparatus 1 or 1A is realized by, for example, a computer that executes instructions of a program that is software realizing the foregoing functions. An example (hereinafter, computer C) of such a computer is illustrated in FIG. 14. FIG. 14 is a block diagram illustrating a hardware configuration of the computer C which functions as the information processing apparatus 1 or 1A.

The computer C includes at least one processor C1 and at least one memory C2. In the memory C2, a program (analysis program) P for causing the computer C to operate as the information processing apparatus 1 or 1A is recorded. In the computer C, the functions of the information processing apparatus 1 or 1A are realized by the processor C1 reading the program P from the memory C2 and executing the program P.

Examples of the processor C1 encompass a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, and a combination thereof. Examples of the memory C2 include a flash memory, a hard disk drive (HDD), a solid state drive (SSD), and a combination thereof.

Note that the computer C may further include a random access memory (RAM) in which the program P is loaded during execution of the program P and/or in which various kinds of data are temporarily stored. The computer C may further include a communication interface via which the computer C transmits and receives data to and from another apparatus. The computer C may further include an input/output interface via which the computer C is connected to an input/output apparatus(es) such as a keyboard, a mouse, a display, and/or a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

The foregoing functions of the information processing apparatus 1 or 1A may be realized by a single processor provided in a single computer, may be realized by cooperation by a plurality of processors provided in a single computer, or may be realized by cooperation by a plurality of processors provided in a respective plurality of computers. A program for causing the information processing apparatus 1 or 1A to realize the foregoing functions may be stored in a single memory provided in a single computer, may be stored dispersedly in a plurality of memories provided in a single computer, or may be stored dispersedly in a plurality of memories provided in a respective plurality of computers.

### [Additional Remark 1]

The present disclosure includes techniques described in supplementary notes below. Note, however, that the present invention is not limited to the techniques described in the supplementary notes below, but may be altered in various ways by a skilled person within the scope of the claims.

### [Additional Remark A]

### (Supplementary Note A1)

An information processing apparatus including: an extraction unit that extracts, from a plurality of pieces of content which are targets, at least one matter selected from the group consisting of a matter that is described as an antecedent and a matter that is described as a consequent in the content, with use of a language model trained by machine learning; and an analysis unit that, in a case where a matter that is described as an antecedent in a certain piece of content among the plurality of pieces of content which are targets and that is also described as a consequent in another piece of content among the plurality of pieces of content is defined as an intermediate matter, associates, on the basis of a result of extraction by the extraction unit, a first matter described as an antecedent in content in which the intermediate matter is described as a consequent and a second matter described as a consequent in content in which the intermediate matter is described as an antecedent.

### (Supplementary Note A2)

The information processing apparatus according to supplementary note A1, wherein the extraction unit uses the language model to: extract a matter described as an antecedent in first content that is one of the plurality of pieces of content; extract, from among the plurality of pieces of content, second content in which the matter extracted is described as a consequent; extract, as the first matter, a matter described as an antecedent in the second content; and extract, as the second matter, a matter described as a consequent in the first content.

### (Supplementary Note A3)

The information processing apparatus according to supplementary note A1, wherein the extraction unit uses the language model to: extract a matter described as a consequent in first content that is one of the plurality of pieces of content; extract, from among the plurality of pieces of content, second content in which the matter extracted is described as an antecedent; extract, as the second matter, a matter described as a consequent in the second content; and extract, as the first matter, a matter described as an antecedent in the first content.

### (Supplementary Note A4)

The information processing apparatus according to supplementary note A1, wherein: the extraction unit uses the language model to extract, from each of the plurality of pieces of content, a matter described as an antecedent in the content and a matter described as a consequent that corresponds to the matter described as the antecedent; and the analysis unit specifies the first matter and the second matter among those extracted matters by specifying, as the intermediate matter, a matter that is described as an antecedent in a certain piece of content among the extracted matters and that is also described as a consequent in another piece of content among the extracted matters, and associate the first matter and the second matter which are thus specified.

### (Supplementary Note A5)

The information processing apparatus according to supplementary note A1, wherein the extraction unit uses the language model to: extract, from the plurality of pieces of content, a piece of content in which a matter described as an antecedent in another piece of content is described as a consequent; extract, as the first matter, a matter described as an antecedent in the piece of content that has been extracted; and extract, as the second matter, a matter which is described as a consequent in the another piece of content in which the matter described as a consequent in the piece of content that has been extracted is described as an antecedent.

### (Supplementary Note A6)

The information processing apparatus according to supplementary note A1, wherein the extraction unit uses the language model to: extract, from the plurality of pieces of content, a piece of content in which a matter described as a consequent in another piece of content is described as an antecedent; extract, as the second matter, a matter described as a consequent in the piece of content that has been extracted; and extract, as the first matter, a matter which is described as an antecedent in the another piece of content in which the matter described as an antecedent in the piece of content that has been extracted is described as a consequent.

### (Supplementary Note A7)

The information processing apparatus according to any one of supplementary notes A1 to A6, further including an inference unit that infers a relation between the first matter and the second matter is inferred, by using (i) first relation information indicating a relation between the first matter and the intermediate matter which are extracted from the content in which the first matter is described as an antecedent and the intermediate matter is described as a consequent and (ii) second relation information indicating a relation between the intermediate matter and the second matter which are extracted from the content in which the intermediate matter is described as an antecedent and the second matter is described as a consequent.

### (Supplementary Note A8)

The information processing apparatus according to any one of supplementary notes A1 to A7, further including a model generation unit which generates, on the basis of a result of association by the analysis unit, a logic model that indicates a logical relation between matters which are described in the plurality of pieces of content.

### (Supplementary Note A9)

The information processing apparatus according to supplementary note A8, further including: a reception unit that receives input of a question; an answer generation unit that generates an answer to the question with use of the logic model; and a presentation unit that presents the answer.

### [Additional Remark B]

### (Supplementary Note B1)

An analysis method including: at least one processor carrying out an extraction process of extracting, from a plurality of pieces of content which are targets, at least one matter selected from the group consisting of a matter that is described as an antecedent and a matter that is described as a consequent in the content, with use of a language model trained by machine learning; and the at least one processor carrying out an analysis process of, in a case where a matter that is described as an antecedent in a certain piece of content among the plurality of pieces of content which are targets and that is also described as a consequent in another piece of content among the plurality of pieces of content is defined as an intermediate matter, associating, on the basis of a result of extraction in the extraction process, a first matter described as an antecedent in content in which the intermediate matter is described as a consequent and a second matter described as a consequent in content in which the intermediate matter is described as an antecedent.

### (Supplementary Note B2)

The analysis method according to supplementary note B1, wherein in the extraction process, the at least one processor uses the language model to: extract a matter described as an antecedent in first content that is one of the plurality of pieces of content; extract, from among the plurality of pieces of content, second content in which the matter extracted is described as a consequent; extract, as the first matter, a matter described as an antecedent in the second content; and extract, as the second matter, a matter described as a consequent in the first content.

### (Supplementary Note B3)

The analysis method according to supplementary note B1, wherein in the extraction process, the at least one processor uses the language model to: extract a matter described as a consequent in first content that is one of the plurality of pieces of content; extract, from among the plurality of pieces of content, second content in which the matter extracted is described as an antecedent; extract, as the second matter, a matter described as a consequent in the second content; and extract, as the first matter, a matter described as an antecedent in the first content.

### (Supplementary Note B4)

The analysis method according to supplementary note B1, wherein: in the extraction process, the at least one processor uses the language model to extract, from each of the plurality of pieces of content, a matter described as an antecedent in the content and a matter described as a consequent that corresponds to the matter described as the antecedent; and in the analysis process, the at least one processor specifies the first matter and the second matter among those extracted matters by specifying, as the intermediate matter, a matter that is described as an antecedent in a certain piece of content among the extracted matters and that is also described as a consequent in another piece of content among the extracted matters, and associate the first matter and the second matter which are thus specified.

### (Supplementary Note B5)

The analysis method according to supplementary note B1, wherein in the extraction process, the at least one processor uses the language model to: extract, from the plurality of pieces of content, a piece of content in which a matter described as an antecedent in another piece of content is described as a consequent; extract, as the first matter, a matter described as an antecedent in the piece of content that has been extracted; and extract, as the second matter, a matter which is described as a consequent in the another piece of content in which the matter described as a consequent in the piece of content that has been extracted is described as an antecedent.

### (Supplementary Note B6)

The analysis method according to supplementary note B1, wherein in the extraction process, the at least one processor uses the language model to: extract, from the plurality of pieces of content, a piece of content in which a matter described as a consequent in another piece of content is described as an antecedent; extract, as the second matter, a matter described as a consequent in the piece of content that has been extracted; and extract, as the first matter, a matter which is described as an antecedent in the another piece of content in which the matter described as an antecedent in the piece of content that has been extracted is described as a consequent.

### (Supplementary Note B7)

The analysis method according to any one of supplementary notes B1 to B6, further including an inference process in which the at least one processor infers a relation between the first matter and the second matter, by using (i) first relation information indicating a relation between the first matter and the intermediate matter which are extracted from the content in which the first matter is described as an antecedent and the intermediate matter is described as a consequent and (ii) second relation information indicating a relation between the intermediate matter and the second matter which are extracted from the content in which the intermediate matter is described as an antecedent and the second matter is described as a consequent.

### (Supplementary Note B8)

The analysis method according to any one of supplementary notes B1 to B7, further including a model generation process in which the at least one processor generates, on the basis of a result of association in the analysis process, a logic model that indicates a logical relation between matters which are described in the plurality of pieces of content.

### (Supplementary Note B9)

The analysis method according to supplementary note B8, further including: a reception process in which the at least one processor receives input of a question; an answer generation process in which the at least one processor generates an answer to the question with use of the logic model; and a presentation process in which the at least one processor presents the answer.

### [Additional Remark C]

### (Supplementary Note C1)

An analysis program for causing a computer to function as: an extraction means that extracts, from a plurality of pieces of content which are targets, at least one matter selected from the group consisting of a matter that is described as an antecedent and a matter that is described as a consequent in the content, with use of a language model trained by machine learning; and an analysis means that, in a case where a matter that is described as an antecedent in a certain piece of content among the plurality of pieces of content which are targets and that is also described as a consequent in another piece of content among the plurality of pieces of content is defined as an intermediate matter, associates, on the basis of a result of extraction by the extraction means, a first matter described as an antecedent in content in which the intermediate matter is described as a consequent and a second matter described as a consequent in content in which the intermediate matter is described as an antecedent.

### (Supplementary Note C2)

The analysis program according to supplementary note C1, wherein the extraction means uses the language model to: extract a matter described as an antecedent in first content that is one of the plurality of pieces of content; extract, from among the plurality of pieces of content, second content in which the matter extracted is described as a consequent; extract, as the first matter, a matter described as an antecedent in the second content; and extract, as the second matter, a matter described as a consequent in the first content.

### (Supplementary Note C3)

The analysis program according to supplementary note C1, wherein the extraction means uses the language model to: extract a matter described as a consequent in first content that is one of the plurality of pieces of content; extract, from among the plurality of pieces of content, second content in which the matter extracted is described as an antecedent; extract, as the second matter, a matter described as a consequent in the second content; and extract, as the first matter, a matter described as an antecedent in the first content.

### (Supplementary Note C4)

The analysis program according to supplementary note C1, wherein: the extraction means uses the language model to extract, from each of the plurality of pieces of content, a matter described as an antecedent in the content and a matter described as a consequent that corresponds to the matter described as the antecedent; and the analysis means specifies the first matter and the second matter among those extracted matters by specifying, as the intermediate matter, a matter that is described as an antecedent in a certain piece of content among the extracted matters and that is also described as a consequent in another piece of content among the extracted matters, and associate the first matter and the second matter which are thus specified.

### (Supplementary Note C5)

The analysis program according to supplementary note C1, wherein the extraction means uses the language model to: extract, from the plurality of pieces of content, a piece of content in which a matter described as an antecedent in another piece of content is described as a consequent; extract, as the first matter, a matter described as an antecedent in the piece of content that has been extracted; and extract, as the second matter, a matter which is described as a consequent in the another piece of content in which the matter described as a consequent in the piece of content that has been extracted is described as an antecedent.

### (Supplementary Note C6)

The analysis program according to supplementary note C1, wherein the extraction means uses the language model to: extract, from the plurality of pieces of content, a piece of content in which a matter described as a consequent in another piece of content is described as an antecedent; extract, as the second matter, a matter described as a consequent in the piece of content that has been extracted; and extract, as the first matter, a matter which is described as an antecedent in the another piece of content in which the matter described as an antecedent in the piece of content that has been extracted is described as a consequent.

### (Supplementary Note C7)

The analysis program according to any one of supplementary notes C1 to C6, for causing the computer to function as an inference means that infers relation between the first matter and the second matter, by using (i) first relation information indicating a relation between the first matter and the intermediate matter which are extracted from the content in which the first matter is described as an antecedent and the intermediate matter is described as a consequent and (ii) second relation information indicating a relation between the intermediate matter and the second matter which are extracted from the content in which the intermediate matter is described as an antecedent and the second matter is described as a consequent.

### (Supplementary Note C8)

The analysis program according to any one of supplementary notes C1 to C7, for causing the computer to function as a model generation means that generates, on the basis of a result of association by the analysis means, a logic model that indicates a logical relation between matters which are described in the plurality of pieces of content.

### (Supplementary Note C9)

The analysis program according to supplementary note C8, for causing a computer to function as: a receiving means that receives input of a question; an answer generation means that generates an answer to the question with use of the logic model; and a presentation means that presents the answer.

### [Additional Remark D]

### (Supplementary Note D1)

An information processing apparatus including at least one processor, the at least one processor carrying out: an extraction process of extracting, from a plurality of pieces of content which are targets, at least one matter selected from the group consisting of a matter that is described as an antecedent and a matter that is described as a consequent in the content, with use of a language model trained by machine learning; and an analysis process of, in a case where a matter that is described as an antecedent in a certain piece of content among the plurality of pieces of content which are targets and that is also described as a consequent in another piece of content among the plurality of pieces of content is defined as an intermediate matter, associating, on the basis of a result of extraction in the extraction process, a first matter described as an antecedent in content in which the intermediate matter is described as a consequent and a second matter described as a consequent in content in which the intermediate matter is described as an antecedent.

The information processing apparatus may further include a memory. The memory may store a program for causing the at least one processor to carry out each of the processes.

### (Supplementary Note D2)

The information processing apparatus according to supplementary note D1, wherein in the extraction process, the at least one processor uses the language model to: extract a matter described as an antecedent in first content that is one of the plurality of pieces of content; extract, from among the plurality of pieces of content, second content in which the matter extracted is described as a consequent; extract, as the first matter, a matter described as an antecedent in the second content; and extract, as the second matter, a matter described as a consequent in the first content.

### (Supplementary Note D3)

The information processing apparatus according to supplementary note D1, wherein in the extraction process, the at least one processor uses the language model to: extract a matter described as a consequent in first content that is one of the plurality of pieces of content; extract, from among the plurality of pieces of content, second content in which the matter extracted is described as an antecedent; extract, as the second matter, a matter described as a consequent in the second content; and extract, as the first matter, a matter described as an antecedent in the first content.

### (Supplementary Note D4)

The information processing apparatus according to supplementary note D1, wherein: in the extraction process, the at least one processor uses the language model to extract, from each of the plurality of pieces of content, a matter described as an antecedent in the content and a matter described as a consequent that corresponds to the matter described as the antecedent; and in the analysis process, the at least one processor specifies the first matter and the second matter among those extracted matters by specifying, as the intermediate matter, a matter that is described as an antecedent in a certain piece of content among the extracted matters and that is also described as a consequent in another piece of content among the extracted matters, and associate the first matter and the second matter which are thus specified.

### (Supplementary Note D5)

The information processing apparatus according to supplementary note D1, wherein in the extraction process, the at least one processor uses the language model to: extract, from the plurality of pieces of content, a piece of content in which a matter described as an antecedent in another piece of content is described as a consequent; extract, as the first matter, a matter described as an antecedent in the piece of content that has been extracted; and extract, as the second matter, a matter which is described as a consequent in the another piece of content in which the matter described as a consequent in the piece of content that has been extracted is described as an antecedent.

### (Supplementary Note D6)

The information processing apparatus according to supplementary note D1, wherein in the extraction process, the at least one processor uses the language model to: extract, from the plurality of pieces of content, a piece of content in which a matter described as a consequent in another piece of content is described as an antecedent; extract, as the second matter, a matter described as a consequent in the piece of content that has been extracted; and extract, as the first matter, a matter which is described as an antecedent in the another piece of content in which the matter described as an antecedent in the piece of content that has been extracted is described as a consequent.

### (Supplementary Note D7)

The information processing apparatus according to any one of supplementary notes D1 to D6, wherein the at least one processor carries out an inference process in which a relation between the first matter and the second matter is inferred, by using (i) first relation information indicating a relation between the first matter and the intermediate matter which are extracted from the content in which the first matter is described as an antecedent and the intermediate matter is described as a consequent and (ii) second relation information indicating a relation between the intermediate matter and the second matter which are extracted from the content in which the intermediate matter is described as an antecedent and the second matter is described as a consequent.

### (Supplementary Note D8)

The information processing apparatus according to any one of supplementary notes D1 to D7, wherein the at least one processor carries out, on the basis of a result of association in the analysis process, a model generation process of generating a logic model that indicates a logical relation between matters which are described in the plurality of pieces of content.

### (Supplementary Note D9)

The information processing apparatus according to supplementary note D8, wherein the at least one processor carries out: a reception process of receiving input of a question; an answer generation process of generating an answer to the question with use of the logic model; and a presentation process of presenting the answer.

### [Additional Remark E]

A non-transitory storage medium in which an analysis program is stored, the analysis program causing a computer to carry out: an extraction process of extracting, from a plurality of pieces of content which are targets, at least one matter selected from the group consisting of a matter that is described as an antecedent and a matter that is described as a consequent in the content, with use of a language model trained by machine learning; and an analysis process of, in a case where a matter that is described as an antecedent in a certain piece of content among the plurality of pieces of content which are targets and that is also described as a consequent in another piece of content among the plurality of pieces of content is defined as an intermediate matter, associating, on the basis of a result of extraction in the extraction process, a first matter described as an antecedent in content in which the intermediate matter is described as a consequent and a second matter described as a consequent in content in which the intermediate matter is described as an antecedent.

### REFERENCE SIGNS LIST

1 information processing apparatus
101 extraction unit (extraction means)
102 analysis unit (analysis means)
1A information processing apparatus
101A extraction unit (extraction means)
102A analysis unit (analysis means)
103A model generation unit (model generation means)
104A inference unit (inference means)
105A reception unit (receiving means)
106A answer generation unit (answer generation means)
107A presentation unit (presenting means)
111A language model
112A logic model

1. An information processing apparatus comprising at least one processor, the at least one processor carrying out:
an extraction process of extracting, from a plurality of pieces of content which are targets, at least one matter selected from the group consisting of a matter that is described as an antecedent and a matter that is described as a consequent in the content, with use of a language model trained by machine learning; and
an analysis process of, in a case where a matter that is described as an antecedent in a certain piece of content among the plurality of pieces of content which are targets and that is also described as a consequent in another piece of content among the plurality of pieces of content is defined as an intermediate matter, associating, on the basis of a result of extraction in the extraction process, a first matter described as an antecedent in content in which the intermediate matter is described as a consequent and a second matter described as a consequent in content in which the intermediate matter is described as an antecedent.

2. The information processing apparatus according to claim 1, wherein in the extraction process, the at least one processor uses the language model to:
extract a matter described as an antecedent in first content that is one of the plurality of pieces of content;
extract, from among the plurality of pieces of content, second content in which the matter extracted is described as a consequent;
extract, as the first matter, a matter described as an antecedent in the second content; and
extract, as the second matter, a matter described as a consequent in the first content.

3. The information processing apparatus according to claim 1, wherein in the extraction process, the at least one processor uses the language model to:
extract a matter described as a consequent in first content that is one of the plurality of pieces of content;
extract, from among the plurality of pieces of content, second content in which the matter extracted is described as an antecedent;
extract, as the second matter, a matter described as a consequent in the second content; and
extract, as the first matter, a matter described as an antecedent in the first content.

4. The information processing apparatus according to claim 1, wherein:
in the extraction process, the at least one processor uses the language model to extract, from each of the plurality of pieces of content, a matter described as an antecedent in the content and a matter described as a consequent that corresponds to the matter described as the antecedent; and
in the analysis process, the at least one processor specifies the first matter and the second matter among those extracted matters by specifying, as the intermediate matter, a matter that is described as an antecedent in a certain piece of content among the extracted matters and that is also described as a consequent in another piece of content among the extracted matters, and associate the first matter and the second matter which are thus specified.

5. The information processing apparatus according to claim 1, wherein in the extraction process, the at least one processor uses the language model to:
extract, from the plurality of pieces of content, a piece of content in which a matter described as an antecedent in another piece of content is described as a consequent;
extract, as the first matter, a matter described as an antecedent in the piece of content that has been extracted; and
extract, as the second matter, a matter which is described as a consequent in the another piece of content in which the matter described as a consequent in the piece of content that has been extracted is described as an antecedent.

6. The information processing apparatus according to claim 1, wherein in the extraction process, the at least one processor uses the language model to:
extract, from the plurality of pieces of content, a piece of content in which a matter described as a consequent in another piece of content is described as an antecedent;
extract, as the second matter, a matter described as a consequent in the piece of content that has been extracted; and
extract, as the first matter, a matter which is described as an antecedent in the another piece of content in which the matter described as an antecedent in the piece of content that has been extracted is described as a consequent.

7. The information processing apparatus according to claim 1, wherein the at least one processor carries out an inference process in which a relation between the first matter and the second matter is inferred, by using (i) first relation information indicating a relation between the first matter and the intermediate matter which are extracted from the content in which the first matter is described as an antecedent and the intermediate matter is described as a consequent and (ii) second relation information indicating a relation between the intermediate matter and the second matter which are extracted from the content in which the intermediate matter is described as an antecedent and the second matter is described as a consequent.

8. The information processing apparatus according to claim 1, wherein the at least one processor carries out, on the basis of a result of association in the analysis process, a model generation process of generating a logic model that indicates a logical relation between matters which are described in the plurality of pieces of content.

9. The information processing apparatus according to claim 8, wherein the at least one processor carries out:
a reception process of receiving input of a question;
an answer generation process of generating an answer to the question with use of the logic model; and
a presentation process of presenting the answer.

10. An analysis method comprising:
at least one processor carrying out an extraction process of extracting, from a plurality of pieces of content which are targets, at least one matter selected from the group consisting of a matter that is described as an antecedent and a matter that is described as a consequent in the content, with use of a language model trained by machine learning; and
the at least one processor carrying out an analysis process of, in a case where a matter that is described as an antecedent in a certain piece of content among the plurality of pieces of content which are targets and that is also described as a consequent in another piece of content among the plurality of pieces of content is defined as an intermediate matter, associating, on the basis of a result of extraction in the extraction process, a first matter described as an antecedent in content in which the intermediate matter is described as a consequent and a second matter described as a consequent in content in which the intermediate matter is described as an antecedent.

11. A computer-readable non-transitory storage medium in which an analysis program is stored, the analysis program causing a computer to carry out:
an extraction process of extracting, from a plurality of pieces of content which are targets, at least one matter selected from the group consisting of a matter that is described as an antecedent and a matter that is described as a consequent in the content, with use of a language model trained by machine learning; and
an analysis process of, in a case where a matter that is described as an antecedent in a certain piece of content among the plurality of pieces of content which are targets and that is also described as a consequent in another piece of content among the plurality of pieces of content is defined as an intermediate matter, associating, on the basis of a result of extraction in the extraction process, a first matter described as an antecedent in content in which the intermediate matter is described as a consequent and a second matter described as a consequent in content in which the intermediate matter is described as an antecedent.
